(19) United States
(12) Patent Application Publication
(10) Pub. No.: US 2017/0278166 A1
(43) Pub. Date: Sep. 28, 2017

(54) METHOD AND APPARATUS FOR PROVIDING INFORMATION ABOUT OBJECT

(71) Applicant: SAMSUNG ELECTRONICS CO., LTD., Suwon-si (KR)

(72) Inventors: Ji-won JEONG, Suwon-si (KR); Do-kyoon KIM, Seongnam-si (KR); Seung-ho SHIN, Suwon-si (KR); Gun-ill LEE, Seongnam-si (KR); Sung-do CHOI, Suwon-si (KR); Chang-yeong KIM, Seoul (KR); Joon-hyun LEE, Seoul (KR)

(21) Appl. No.: 15/467,238

(22) Filed: Mar. 23, 2017

(30) Foreign Application Priority Data
Mar. 28, 2016 (KR) 10-2016-0036965
Apr. 29, 2016 (KR) 10-2016-0053546

(51) Int. Cl. G06Q 30/06; G06K 9/00; G06K 9/62

(52) U.S. Cl. CPC G06Q 30/0623; G06K 9/6267; G06K 9/00671; G06K 2209/19

(57) ABSTRACT

A method of providing, by a device, information about an object is provided. The method includes analyzing a shape of the object based on an image including the object to determine what kind of object it is, identifying the object, based on an identification reference corresponding to the determined kind of the object from among a plurality of identification references which are previously set in the device, and displaying information about the identified object on a screen of the device.

### CROSS-REFERENCE TO RELATED APPLICATIONS

This application is based on and claims priority under 35 U.S.C. §119 to Korean Patent Application Nos. 10-2016-0036965, filed on Mar. 28, 2016 and 10-2016-0053546, filed on Apr. 29, 2016, in the Korean Intellectual Property Office, the disclosures of which are incorporated by reference herein in their entireties.

### BACKGROUND

### 1. Field

The present disclosure relates generally to a method of providing information about an object, a device for providing information about an object, and a non-transitory computer-readable recording medium storing a program for executing the method of providing the information about the object.

### 2. Description of Related Art

With advances in information technology (IT), a user may easily obtain, through the Internet, information about an object desired by the user. Particularly, with the advances in IT, an online shopping mall platform has been developed, and thus, a user may obtain, through the Internet, information about a certain product to purchase.

However, in the related art, in order for a user to obtain information about a certain object, the user may be required to input, in the form of text, a name indicating the certain object to search for the information, and for this reason, if the user does not previously know the name of the certain object, the information about the certain object cannot be obtained. Also, development of technology for enabling a user to easily obtain information about an object even when the user does not recognize a name of the object is required.

### SUMMARY

A method and an apparatus are provided, which identify an object from an image obtained by photographing the object, and obtain information about the identified object, thereby easily providing a user with the information about the object.

Additional aspects will be set forth in part in the description which follows and, in part, will be apparent from the description.

According to an aspect of an example embodiment, a method of providing, by a device, information about an object includes: analyzing a shape of the object based on an image including the object to determine a kind of the object, identifying the object, based on an identification reference corresponding to the determined kind of the object from among a plurality of identification references which are previously set in the device, and displaying information about the identified object on a screen of the device.

The identifying of the object may include detecting at least one portion of the object, indicated by the identification reference corresponding to the determined kind of the object, from the image including the object and comparing the detected at least one portion of the object with partial feature information about each of a plurality of objects, which is previously stored in association with the determined kind of the object, to identify the object.

The partial feature information comprises information about a ratio of the at least one portion of the object to a ratio of a screen length and information about a shape, a texture, and a color of the at least one portion of the object.

The information about the identified object may include at least one of performance information about the object, price information about the object, and user reaction information about the object.

The method may further include providing guide information for obtaining an additional image including the object, when the object is sensed based on the provided guide information, obtaining the additional image including the object, and selecting at least one identification reference from among the previously set plurality of identification references, based on the obtained additional image.

The method may further include, when text is included in the image including the object, identifying the text and identifying the object, based on the identified text.

The displaying may include displaying the information about the identified object within a certain distance range from the object in an image of the object displayed on the screen of the device.

The method may further include: requesting the information about the identified object from an external server, wherein the displaying may include displaying the information about the identified object, which is received in response to the request.

The identifying of the object may include, when a plurality of candidate objects are predicted as the object as a result of the identification of the object, selecting a detailed identification reference for identifying the plurality of candidate objects, based on the selected identification reference and selecting one candidate object from among the plurality of candidate objects, based on the selected detailed identification reference.

According to an aspect of another example embodiment, a method of providing, by a server, information about an object includes receiving an image including the object from a device, analyzing a shape of the object based on the image including the object to determine a kind of object, identifying an object, based on an identification reference corresponding to the determined kind of the object from among a plurality of identification references which are previously set in the server, and transmitting information about the identified object to the device.

According to an aspect of another example embodiment, a device for providing information about an object includes a photographing unit comprising a camera configured to obtain an image including the object, a controller configured to analyze a shape of the object based on an image including the object to determine a kind of the object, and to identify the object, based on an identification reference corresponding to the determined kind of the object from among a plurality of identification references which are previously set in the device, and an output configured to display information about the identified object on a screen of the device.

The controller may detect at least one portion of the object, indicated by the identification reference corresponding to the determined kind of the object, from the image including the object and may compare the detected at least one portion of the object with partial feature information about each of a plurality of objects, which is previously stored in association with the determined kind of the object, to identify the object.

The partial feature information comprises information about a ratio of the at least one portion of the object to a ratio of a screen length and information about a shape, a texture, and a color of the at least one portion of the object.

The information about the identified object may include at least one of performance information about the object, price information about the object, and user reaction information about the object.

The controller may provide guide information for obtaining an additional image including the object, obtains the additional image including the object when the object is sensed based on the provided guide information, and may select at least one identification reference from among the previously set plurality of identification references, based on the obtained additional image.

When text is included in the image including the object, the controller may identify the text and identifies the object, based on the identified text.

The output may display the information about the identified object within a certain distance range from the object in an image of the object displayed on the screen of the device.

The device may further include a communicator comprising communication circuitry configured to request the information about the identified object from an external server, wherein the output unit may display the information about the identified object, which is received in response to the request.

When a plurality of candidate objects are predicted as the object as a result of the identification of the object, the controller may select a detailed identification reference for identifying the plurality of candidate objects, based on the selected identification reference and may select one candidate object from among the plurality of candidate objects, based on the selected detailed identification reference.

According to an aspect of another example embodiment, a server for providing information about an object includes a communicator comprising communication circuitry configured to receive an image including the object from a device and a controller configured to analyze a shape of the object based on the image including the object to determine a kind of the object, and to identify an object, based on an identification reference corresponding to the determined kind of the object from among a plurality of identification references which are previously set in the server, wherein the communicator is configured to transmit information about the identified object to the device.

### BRIEF DESCRIPTION OF THE DRAWINGS

These and/or other aspects, features and attendant advantages of the present disclosure will become apparent and more readily appreciated from the following detailed description, taken in conjunction with the accompanying drawings, in which like reference numerals refer to like elements, and wherein:

FIG. 1 is a flowchart illustrating an example method of providing, by a device, information about an object, according to an example embodiment of the present disclosure;

FIG. 2 is a diagram illustrating an example method of providing, by a device, information about an object, according to an example embodiment of the present disclosure;

FIG. 3 is a flowchart illustrating an example method of providing, by a device, information about an object, according to an example embodiment of the present disclosure;

FIG. 4 is a diagram illustrating an example method of identifying, by a device, an object, according to an example embodiment of the present disclosure;

FIG. 5 is a diagram illustrating example partial feature information of each of a plurality of objects stored in a device, according to an example embodiment of the present disclosure;

FIG. 6 is a diagram illustrating example partial feature information of each of a plurality of objects stored in a device, according to another example embodiment of the present disclosure;

FIG. 7 is a diagram illustrating example partial feature information of each of a plurality of objects stored in a device, according to another example embodiment of the present disclosure;

FIG. 8 is a flowchart illustrating an example method of identifying, by a device, according to an example embodiment of the present disclosure, an object;

FIG. 9 is a diagram illustrating an example method of identifying, by a device, an object, according to an example embodiment of the present disclosure;

FIG. 10 is a diagram illustrating an example method of identifying, by a device, an object classified as a smart television (TV), based on a detailed identification reference, according to an example embodiment of the present disclosure;

FIG. 11 is a diagram illustrating an example method of displaying, by a device, information about an identified object on an image including the object, according to an example embodiment of the present disclosure;

FIG. 12 is a diagram illustrating an example method of displaying, by a device, pieces of information about a plurality of objects on an image including the plurality of objects, according to an example embodiment of the present disclosure;

FIG. 13 is a diagram illustrating an example method of receiving, by a device, information about an identified object from an external server, according to an example embodiment of the present disclosure;

FIG. 14 is a flowchart illustrating an example method of identifying, by a device, an object when a text is included in an image including the object, according to an example embodiment of the present disclosure;

FIG. 15 is a diagram illustrating an example method of identifying, by a device, an object based on a letter string included in an image including the object, according to an example embodiment of the present disclosure;

FIG. 16 is a flowchart illustrating an example method of providing, by a server, information about an object, according to an example embodiment of the present disclosure;

FIG. 17 is a flowchart illustrating an example method of providing, by a device, information about an identified object based on an obtained additional image according to guide information being provided, according to an example embodiment of the present disclosure;

FIG. 18 is a diagram illustrating an example method of selecting, by a device, one object from among a plurality of objects included in an image, based on a user input, according to an example embodiment of the present disclosure;

FIG. 19 is a diagram illustrating an example method of selecting, by a device, an object from an image including the object, according to an example embodiment of the present disclosure;

FIG. 20 is a diagram illustrating an example method of providing, by a device, voice guide information, according to an example embodiment of the present disclosure;

FIGS. 21A, 21B and 21C are diagrams illustrating an example method of providing, by a device, image guide information, according to an example embodiment of the present disclosure;

FIG. 22 is a diagram illustrating an example method of providing, by a device, information about an identified object, according to an example embodiment of the present disclosure;

FIG. 23 is a block diagram illustrating an example device for providing information about an identified object, according to an example embodiment of the present disclosure;

FIG. 24 is a block diagram illustrating an example device for providing information about an identified object, according to another example embodiment of the present disclosure; and

FIG. 25 is a block diagram illustrating an example server for providing information about an identified object, according to an example embodiment of the present disclosure.

### DETAILED DESCRIPTION

Reference will now be made in greater detail to embodiments, examples of which are illustrated in the accompanying drawings, wherein like reference numerals refer to like elements throughout. In this regard, the various example embodiments may have different forms and should not be construed as being limited to the descriptions set forth herein. Accordingly, the embodiments are described below, by referring to the figures, to explain various example aspects. As used herein, the term “and/or” includes any and all combinations of one or more of the associated listed items. Expressions such as “at least one of” when preceding a list of elements, modify the entire list of elements and do not modify the individual elements of the list.

Terms used herein will be briefly described, and the example embodiments will be described in greater detail.

Terms used in the present disclosure have been selected as general terms which are widely used at present, in consideration of the functions of the present disclosure, but may be altered according to the intent of an operator of ordinary skill in the art, conventional practice, or introduction of new technology. Also, if there is a term which is arbitrarily selected in a specific case, in which case a meaning of the term will be described in detail in a corresponding description portion of the present disclosure. Therefore, the terms should be defined on the basis of the entire content of this discloure instead of a simple name of each of the terms.

In this disclosure below, when it is described that one comprises (or includes or has) some elements, it should be understood that it may comprise (or include or have) only those elements, or it may comprise (or include or have) other elements as well as those elements if there is no specific limitation. Moreover, each of terms such as “ . . . unit”, “ . . . apparatus” and “module” described in the disclosure denotes an element for performing at least one function or operation, and may be implemented in hardware, software or a combination of hardware and software.

Hereinafter, example embodiments will be described in detail to be easily embodied by those of ordinary skill in the art with reference to the accompanying drawings. The present disclosure may, however, be embodied in many different forms and should not be construed as being limited to the embodiments set forth herein. In the accompanying drawings, portions irrelevant to a description of the present disclosure may be omitted for clarity. Moreover, like reference numerals refer to like elements throughout.

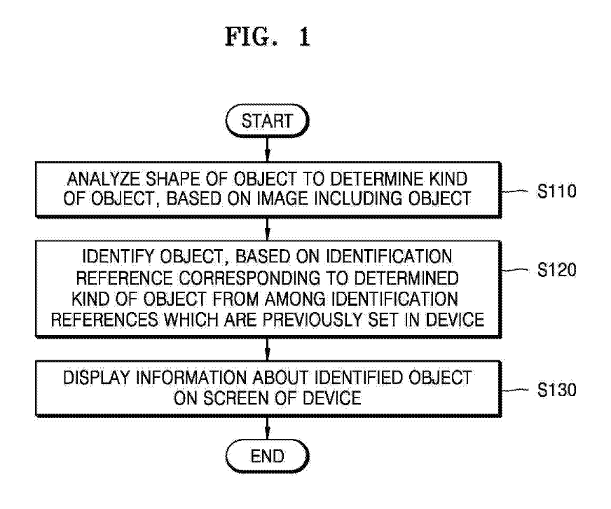

FIG. 1 is a flowchart illustrating an example method of providing, by a device, information about an object, according to an example embodiment of the present disclosure.

In operation S110, the device may analyze a shape of an object based on an image including the object to determine what kind of object it is.

The device according to an embodiment may obtain the image including the object. For example, the device may photograph the object by using a camera included therein. According to another embodiment, the device may obtain the image including the object from an external device.

The device according to an embodiment may analyze a shape of the object in the image including the object. For example, the device may recognize a contour of the object in the image including the object. Also, when a plurality of objects are displayed on the image including the object, the device may select an object located in a certain area such as a center portion of the image and may analyze a shape of the selected object.

The device according to an embodiment may determine the kind of the object, based on a result of the analysis of the shape of the object. Here, the kind of the object may be classified based on a function which the object performs, and for example, the object may be classified, for example, and without limitation, as a smart TV, a washing machine, a smartphone, or a refrigerator, but this is merely an example embodiment. The kind of the object is not limited thereto. The above-described example is an electronic device, but the object is not limited to the electronic device.

For example, when the device recognizes the shape of the object from the image including the object, the device may compare the recognized shape of the object with shapes of a plurality of kinds of objects which are previously stored. Also, the device may calculate a degree to which the recognized shape of the object matches the shape of each of the plurality of kinds of objects which are previously stored, thereby determining what kind of object is the recognized object.

In operation S120, the device may identify the object, based on an identification reference corresponding to the determined kind of the object from among a plurality of identification references which are previously set in the device.

The device according to an embodiment may previously set an identification reference for each of the plurality of kinds of objects. For example, the device may previously set an identification reference for the smart TV to a stand shape, a bezel shape, a screen shape, and a logo.

The device according to an embodiment may select an identification reference corresponding to a kind of an object from among identification references which are previously set for kinds of a plurality of objects. Also, the device may identify the object, based on the selected identification reference. For example, when the kind of the object is determined as a smart TV, the device may identify the object, based on a stand shape, a bezel shape, a screen shape, and a logo which are identification references corresponding to the smart TV.

In operation S130, the device may display information about the identified object on a screen of the device.

As the object is identified, the device according to an embodiment may obtain the information about the identified object. Here, the information about the identified object may include price information and performance information about the object and reaction information about a user reaction to the object, but this is merely an example embodiment. The information about the identified object is not limited to the above-described example.

Moreover, the device may receive the information about the identified object from an external server. For example, the device may receive the price information and performance information about the identified object from an online shopping mall server that provides a service for selling the identified object. According to another embodiment, the device may receive user reaction information, including a review about the identified object, from a social network service (SNS) server.

The device according to an embodiment may display the information about the identified object within a predetermined distance range from a location, at which the object is displayed, in a screen of the device. For example, when an image including an object is being displayed on a screen of the device, the device may display at least one of price information and performance information about an identified object and user reaction information within a predetermined distance range from a location of the object in the displayed image.

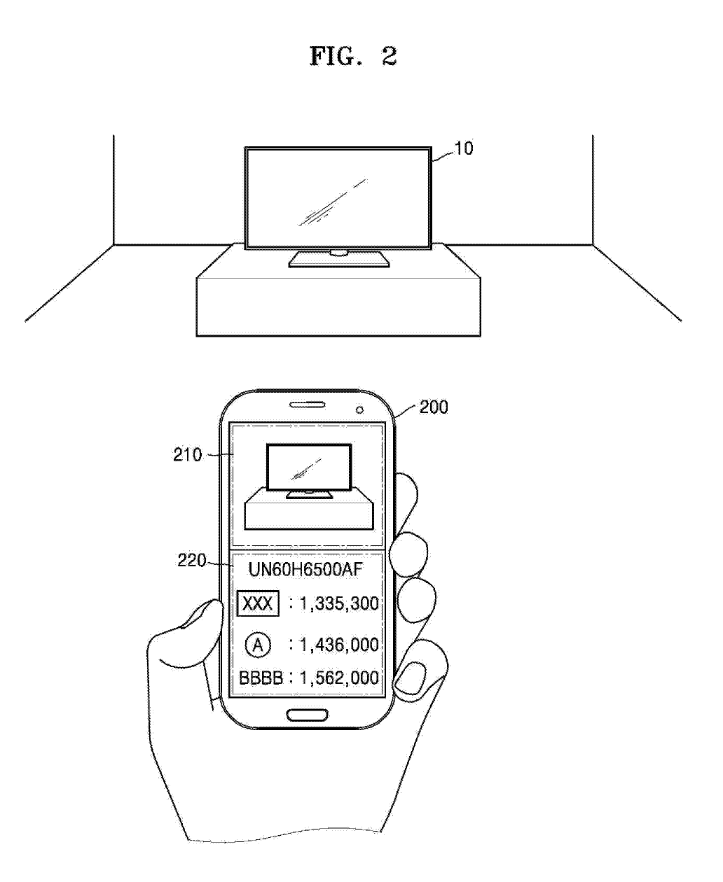

FIG. 2 is a diagram illustrating an example method of providing, by a device 200, information about an object, according to an example embodiment of the present disclosure.

Referring to FIG. 2, for example, the device 200 may photograph an object 10. Therefore, the device 200 may obtain an image 210 by photographing the object 10.

Moreover, the device 200 may analyze a shape of the object 10 based on the image 210 of the photographed object 10 to determine what kind of object is an object corresponding to the object 10. For example, the device 200 may recognize a contour of the object 10 in the image 210 of the photographed object 10 and may compare the recognized contour with contours of a plurality of kinds of objects which are previously stored. Also, the device 200 may calculate a degree, to which the recognized contour matches the contour of each of the plurality of kinds of objects which are previously stored, to determine a kind of the object 10 as a smart TV.

The device 200 according to an embodiment may select an identification reference corresponding to a smart TV from among a plurality of identification references which are previously set in the device 200. Therefore, the device 200 may identify the object 10, based on the selected identification reference such as a stand shape, a bezel shape, a screen shape, and/or a logo. For example, the device 200 may determine whether a stand of the object 10 corresponds to one of a Y-shape, a T-shape, and an L-shape. However, this is merely an example embodiment, and the device 200 may determine a thickness of the stand of the object 10 and a location on which the stand is attached. Also, the device 200 may determine a convex degree or a thickness of a bezel of the object 10. The device 200 may determine whether a screen of the object 10 is curved or planar in shape.

The device 200 according to an embodiment may identify, as a result of the analysis, the object 10 as an A-10 smart TV released from S company, based on the identification reference corresponding to the smart TV.

The device 200 according to an embodiment may receive information 220 about the identified object 10 from an external server. For example, the device 200 may receive price information and performance information, provided from each of online shopping malls that sell the object 10, from the external server. According to another embodiment, the device 200 may receive reaction information about users using the object 10 from an SNS server.

The device 200 according to an embodiment may display the received information 220 on a screen of the device 200. For example, the device 200 may display the price information, provided from each of online shopping malls that sell the object 10, on the screen of the device 200. Therefore, a user of the device 200 may determine whether to purchase the object 10, based on the price information displayed on the screen of the device 200. Also, when the user of the device 200 selects one online shopping mall from among the online shopping malls, the device 200 may display a user interface of the selected online shopping mall on the screen in order to purchase the object 10 from the selected online shopping mall.

The device 200 may be a TV as illustrated in FIG. 2, but this is merely an example. In other embodiments, the device 200 may be implemented as an electronic device including a display. For example, the device 100 may be implemented as various electronic devices such as a portable phone, a tablet personal computer (PC), a digital camera, a camcorder, a notebook computer, a laptop computer, a desktop computer, an E-book device, a digital broadcasting device, a personal digital assistant (PDA), a portable multimedia player (PMP), a navigation device, an MP3 player, a wearable device, or the like, but is not limited thereto. Particularly, in embodiments, the device 200 may be easily implemented in a display apparatus including a large display like TVs, but is not limited thereto. Also, the device 200 may be a fixed type or a movable type, and for example, may be a digital broadcasting receiver capable of receiving digital broadcasts.

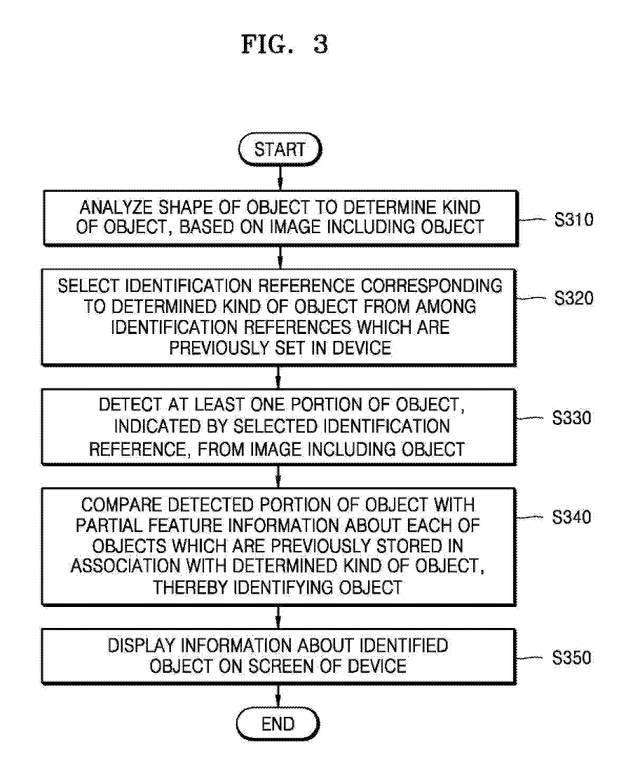

FIG. 3 is a flowchart illustrating an example method of providing, by a device, information about an object, according to an example embodiment of the present disclosure.

In operation S310, the device may analyze a shape of an object to determine what kind of object it is, based on an image including the object.

The device according to an embodiment may obtain the image including the object. Also, the device according to an embodiment may analyze the shape of the object in the obtained image. The device according to an embodiment may determine the kind of the object, based on a result of the analysis.

Operation S310 may correspond to operation S110 described above with reference to FIG. 1.

In operation S320, the device may select an identification reference corresponding to the determined kind of the object from among a plurality of identification references which are previously set in the device.

The device according to an embodiment may store information about an identification reference which is previously set for each of kinds of a plurality of objects. For example, the device may store information about an identification reference which is previously set for each of a smart TV, a washing machine, and a refrigerator.

As the kind of the object is determined in operation S310 described above, the device according to an embodiment may select an identification reference corresponding to the kind of the object from among a plurality of identification references. For example, when the kind of the object is a washing machine, the device may select a shape and a location of a control panel, based on the identification reference corresponding to the kind of the object.

In operation S330, the device may detect at least one portion of the object, indicated by the selected identification reference, from the image including the object.

For example, when the shape and the location of the control panel are selected based on the identification reference, the device may detect a portion, corresponding to the control panel, of the image including the object.

In operation S340, the device may compare the detected portion of the object with partial feature information about each of a plurality of objects which are previously stored in association with the determined kind of the object, thereby identifying the object.

The device according to an embodiment may previously store the partial feature information corresponding to each of the plurality of objects. For example, the device may previously store information about the shape and the location of the control panel of the washing machine, based on a washing machine selling company and a washing machine model.

The device according to an embodiment may compare the detected portion of the object with the partial feature information about each of the stored plurality of objects. For example, the device may compare the detected shape and location of the control panel of the object with pre-stored shape and location information about a control panel of each of a plurality of washing machines.

The device according to an embodiment may determine, based on a result of the comparison, a degree to which the detected portion matches the partial feature information, thereby identifying the object. For example, when a degree to which a shape and a location of a control panel of a D-10 washing machine released from S company match the detected shape and location of the control panel of the object is higher than another washing machine, the device may identify the object as the D-10 washing machine released from the S company.

In operation S350, the device may display information about the identified object on a screen of the device.

The device according to an embodiment may display information about an identified object, received from an external server, on the screen of the device. According to another embodiment, the device may detect information about an identified object from among pieces of information about at least one pre-stored object and may display the detected information on the screen of the device.

Operation S350 may correspond to operation S130 described above with reference to FIG. 1.

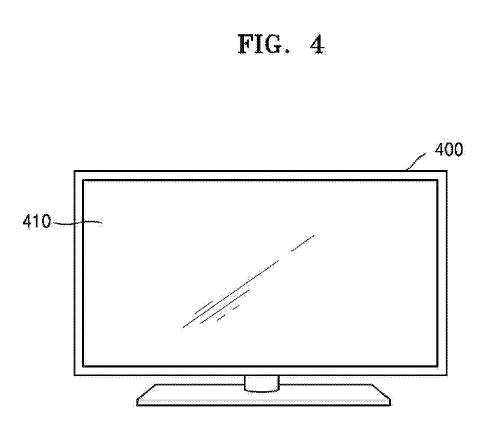

FIG. 4 is a diagram illustrating an example method of identifying, by a device, an object 410, according to an example embodiment of the present disclosure.

Referring to FIG. 4, the device may obtain an image by photographing the object 410. The device according to an embodiment may recognize a contour of the object 410 in the obtained image 400 to determine what kind of object is the object 410. For example, the device may determine the kind of the object 410 to be a smart TV.

The device according to an embodiment may analyze a shape. The device may determine what kind of object is included in the obtained image 400, based on a result of the analysis. Also, as the kind of the object 410 is determined, the device may select an identification reference corresponding to the determined kind of the object 410 from among a plurality of identification references which are previously set. For example, as the kind of the object 410 is determined to be the smart TV, the device may select a logo and shapes of a stand and a bezel of the object 410, based on the identification reference.

The device according to an embodiment may detect a portion of the object 410 corresponding to the selected identification reference from the obtained image 400. For example, the device may detect a portion, corresponding to each of the logo, the stand, and the bezel, from the obtained image 400.

The device according to an embodiment may sequentially apply identification references to the obtained image 400 to identify the object. For example, the device may identify a brand of the object 410, based on the logo and the shape of the stand. The device may identify a product name of the object 410 in the identified brand, based on the shapes of the stand and the bezel. Also, the device may identify the object 410 in the identified product name, based on a shape of a screen based on the shape of the bezel.

When there are a plurality of candidate objects predicted as the object 410 as a result of the identification, the device may identify an object from among the plurality of candidate objects, based on an identifiable detailed identification reference. For example, the device may detect a ratio of a screen length to a logo length or may detect a ratio of a screen size to the screen length and the logo length, thereby identifying the object 410. However, this is merely an example embodiment of a detailed identification reference, and the detailed identification reference is not limited to the above-described example.

As the object 410 is identified, the device according to an embodiment may display information about the object 410 on the screen of the device. For example, the device may display price information and performance information, including a resolution and a screen size, on the screen of the device. Also, according to another embodiment, the device may display reaction information about a user using the object 410 on the screen of the device. Also, according to another embodiment, the device may display information about another object, having performance or a price similar to that of the object 410 among another plurality of objects which are the same as the object 410, on the screen of the device.

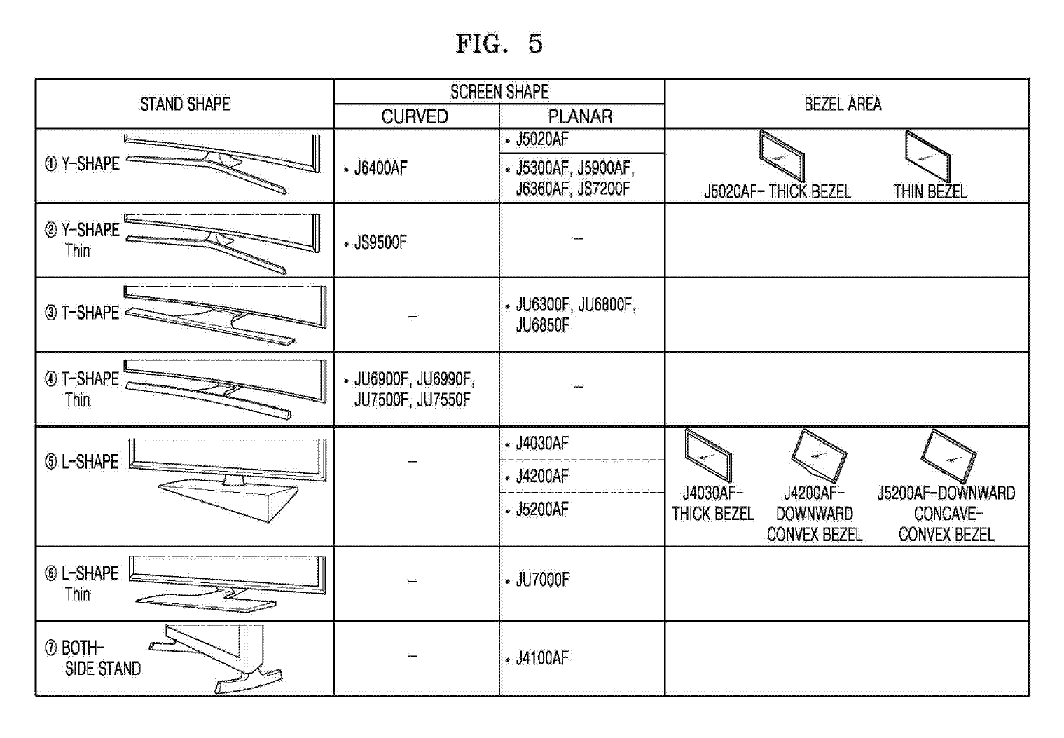

FIG. 5 is a diagram illustrating example partial feature information of each of a plurality of objects stored in a device, according to an example embodiment of the present disclosure.

The device according to an embodiment may previously set an identification reference for a smart TV. For example, the device may previously set an identification reference for the smart TV to shapes of a stand, a bezel, and a screen.

Referring to FIG. 5, the shape of the stand of the smart TV may be classified as a Y-shape, a thin Y-shape, a T-shape, a thin T-shape, an L-shape, a thin L-shape, and a both-side stand shape. Also, the shape of the screen of the smart TV may be classified as a curved shape and a planar shape. Also, the shape of the bezel of the smart TV may be classified as a thick shape, a thin shape, a downward convex shape, and a downward concave-convex shape.

The device according to an embodiment may apply identification references to an obtained image in the order of the shape of the stand, the shape of the screen, and the shape of the bezel to analyze an object in the obtained image. For example, the device may analyze a stand shape of the object to select J6400AF, J5020AF, J5300AF, J5900AF, J6360AF, and JS7200F, which are smart TVs having a Y-shaped stand, from among a plurality of smart TVs. Also, the device may analyze shapes of screens of smart TVs selected based on a shape of a stand to select J5300AF, J5900AF, J6360AF, and JS7200F, which have a planar screen, from among a plurality of smart TVs having a Y-shaped stand. Also, the device may analyze shapes of bezels of smart TVs selected based on a shape of a screen to select J5020AF having a thick bezel. Accordingly, the device may identify an object as a J5020AF smart TV.

However, this is merely an example embodiment. An order in which selected identification references are applied to an image including an object may be changed based on a setting of a user, for identifying the object in a device.

As an object is identified, the device according to an embodiment may display information about the identified object on the screen of the device.

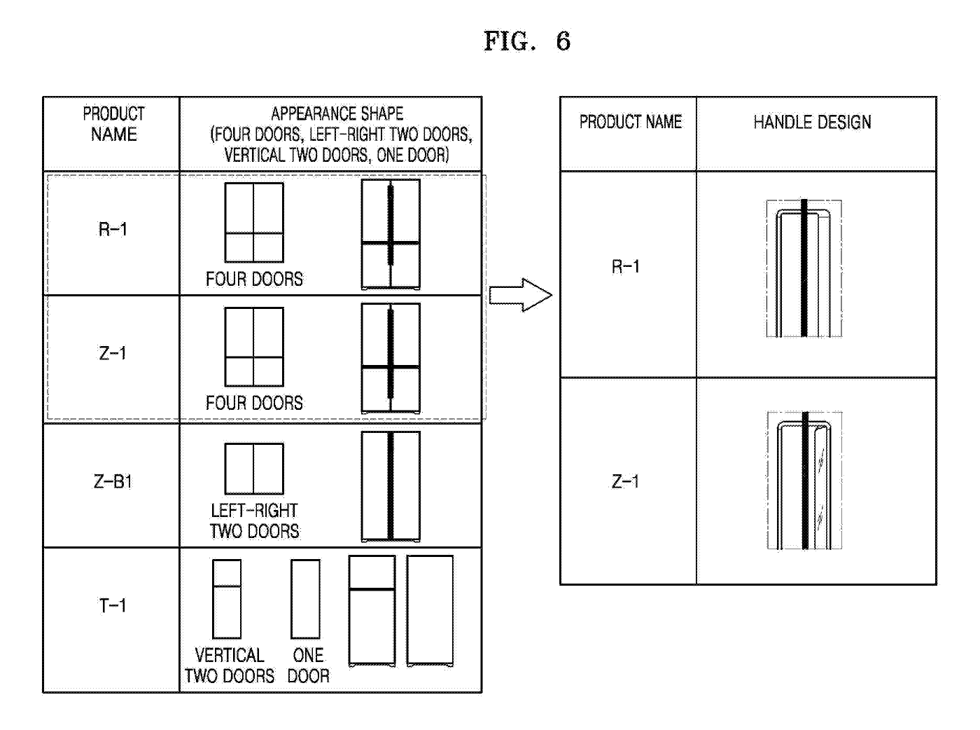

FIG. 6 is a diagram illustrating example partial feature information of each of a plurality of objects stored in a device, according to another example embodiment of the present disclosure.

The device according to an embodiment may previously set an identification reference for a refrigerator. For example, the device may set the identification reference for the refrigerator to an appearance shape and a handle design.

Referring to FIG. 6, the appearance shape of the refrigerator may be classified as a four door type, a left-right two door type, a vertical two door type, and a one door type. Also, the handle design of the refrigerator may be classified based on a texture, a color, and a logo.

The device according to an embodiment may apply identification references to an obtained image in the order of the appearance shape and the handle design of the refrigerator to analyze an object in the obtained image. For example, the device may analyze an appearance shape of the object to select R-1 and Z-1, which are a four door type, from among a plurality of refrigerators. Also, the device may analyze a handle design of a refrigerator selected based on an appearance shape to select R-1 having a color-processed metal design from among refrigerators which are a four door type. Accordingly, the device may identify an object as an R-1 refrigerator.

However, this is merely an example embodiment. An order in which selected identification references are applied to an image including an object may be changed based on a setting of a user, for identifying the object in a device.

As an object is identified, the device according to an embodiment may display information about the identified object on a screen of the device.

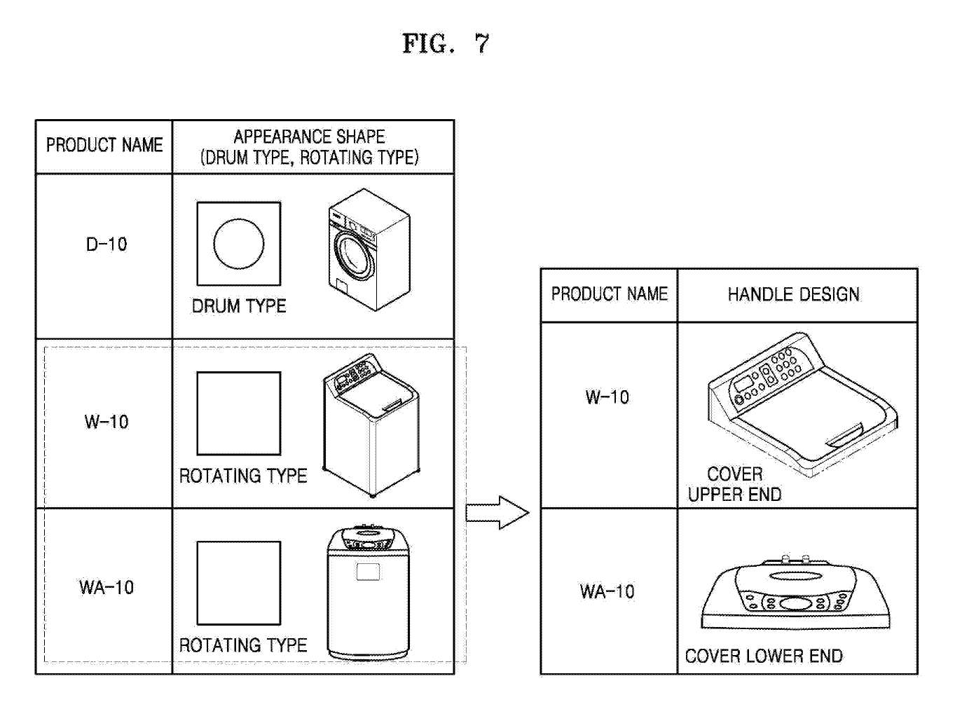

FIG. 7 is a diagram illustrating example partial feature information of each of a plurality of objects stored in a device, according to another example embodiment of the present disclosure.

The device according to an embodiment may previously set an identification reference for a washing machine. For example, the device may set the identification reference for the washing machine to an appearance shape and a location of a control panel.

Referring to FIG. 7, the appearance shape of the washing machine may be classified as a drum type and a rotating type. Also, the location of the control panel of the washing machine may be classified based on a cover upper end and a cover lower end.

The device according to an embodiment may apply identification references to an obtained image in the order of the appearance shape and the control panel location of the washing machine to analyze an object in the obtained image. For example, the device may analyze an appearance shape of the object to select W-10 and WA-10, which are a rotating type, from among a plurality of washing machines. Also, the device may analyze a control panel location of a washing machine selected based on an appearance shape to select W-10, where a control panel is located in a cover upper end of a washing machine, from among washing machines which are a rotating type. Accordingly, the device may identify an object as a W-10 washing machine.

However, this is merely an example embodiment. An order in which selected identification references are applied to an image including an object may be changed based on a setting of a user, for identifying the object in a device.

As an object is identified, the device according to an embodiment may display information about the identified object on a screen of the device.

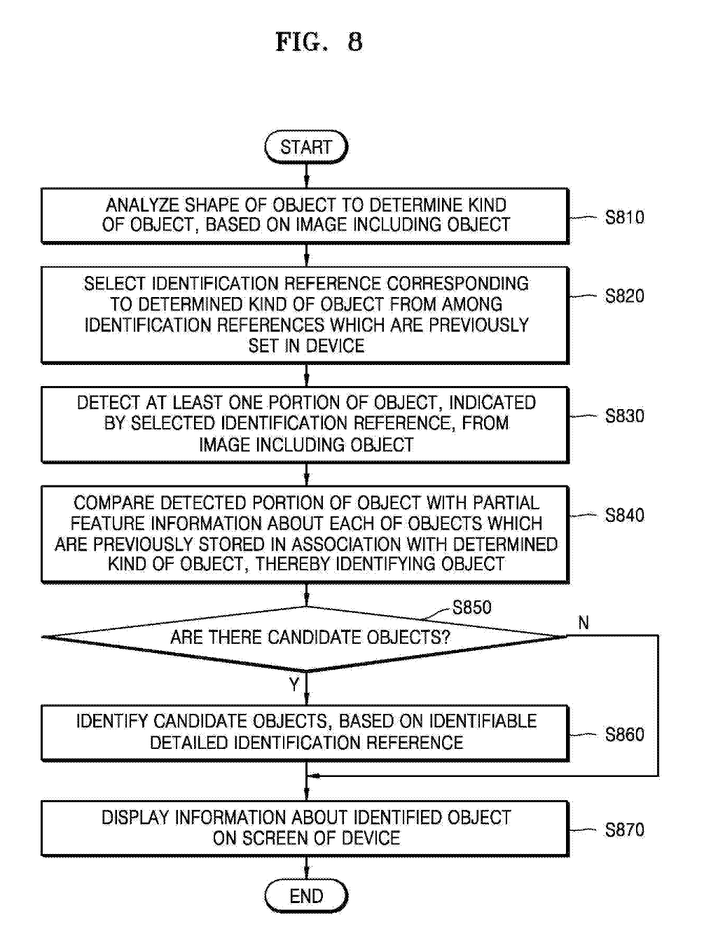

FIG. 8 is a flowchart illustrating an example method of identifying, by a device, an object, according to an example embodiment of the present disclosure.

In operation S810, the device may analyze a shape of an object to determine what kind of object it is, based on an image including the object.

Operation S810 may correspond to operation S310 described above with reference to FIG. 3.

In operation S820, the device may select an identification reference corresponding to the determined kind of the object from among a plurality of identification references which are previously set (e.g., stored) in the device.

Operation S820 may correspond to operation S320 described above with reference to FIG. 3.

In operation S830, the device may detect at least one portion of the object, indicated by the selected identification reference, from the image including the object.

Operation S830 may correspond to operation S330 described above with reference to FIG. 3.

In operation S840, the device may compare the detected portion of the object with partial feature information about each of a plurality of objects which are previously stored in association with the determined kind of the object, thereby identifying the object.

Operation S840 may correspond to operation S340 described above with reference to FIG. 3.

In operation S850, the device may determine whether there are a plurality of candidate objects predicted as the object.

The device according to an embodiment may determine whether there are a plurality of candidate objects predicted as the object, based on a result obtained by comparing the detected portion of the object with the partial feature information about each of the plurality of objects. For example, the device may determine whether there are a plurality of smart TVs predicted as the object as a result obtained by identifying the object, based on shapes of a screen, a stand, and a bezel.

In operation S860, the device may identify the plurality of candidate objects, based on an identifiable detailed identification reference.

When there are the plurality of candidate objects predicted as the object, the device according to an embodiment may select a detailed identification reference to identify the object. Here, the detailed identification reference may be determined based on features of objects determined as candidate objects. For example, the device may compare smart TVs determined as candidate objects, and when ratios of log lengths to stand lengths of the smart TVs differ as a result of the comparison, the device may select a ratio of a log length to a stand length as a detailed identification reference. Accordingly, the device may compare the ratios of the log lengths to the stand lengths of the smart TVs to identify a candidate object, which is the highest in degree to which one object matches another object, as an object.

In operation S870, the device may display information about the identified object on a screen of the device.

The device according to an embodiment may display the information about the object, which has been identified in operation S860, on the screen of the device. Also, when it is determined in operation S850 that there is one candidate object, the device according to another embodiment may identify the determined candidate object as an object. Accordingly, the device may display information about the determined candidate object on the screen of the device.

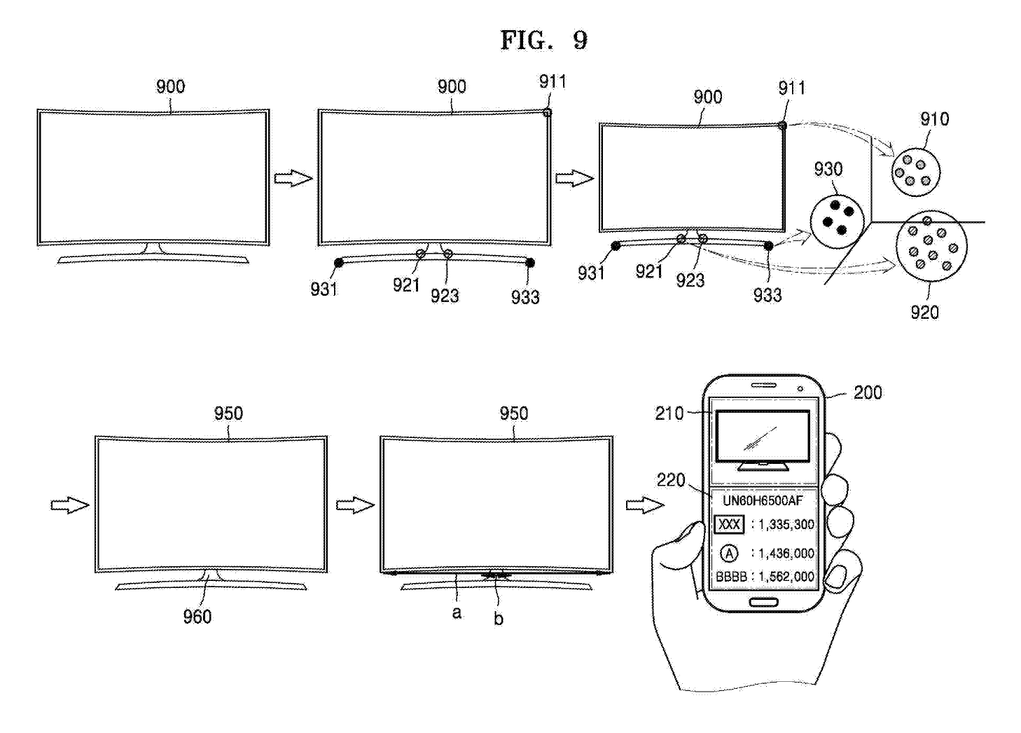

FIG. 9 is a diagram illustrating an example method of identifying, by a device 200, an object, according to an example embodiment of the present disclosure.

Referring to FIG. 9, the device 200 according to an embodiment may analyze a shape of the object 900 to determine what kind of object is the object 900, based on an image including an object. The device 200 may determine the kind of the object 900 to be a smart TV.

The device 200 may select an identification reference corresponding to the determined kind of the object from among a plurality of identification references which are previously set in the device 200. For example, the device 200 may select a screen, a stand, and a logo as identification references. Therefore, the device 200 may detect portions 911, 921, 923, 931, and 933 of at least one object, corresponding to the selected identification reference, from an image obtained by photographing the object 900. The device 200 may classify the detected portions 911, 921, 923, 931, and 933 of the at least one object, based on the identification reference. For example, the device 200 may select at least one smart TV from among smart TVs of a group 910 which is classified based on a shape of a screen with respect to a first portion 911. Also, the device 200 may select at least one smart TV from among smart TVs of a group 920 which is classified based on a logo with respect to a second portion 921 and a third portion 923. Also, the device 200 may select at least one smart TV from among smart TVs of a group 930 which is classified based on a shape of a stand with respect to a fourth portion 931 and a fifth portion 933.

The device 200 according to an embodiment may identify an object, based on the selected identification reference and when there are a plurality of candidate objects predicted as the object as a result of the identification, the device 200 may select a detailed identification reference. For example, the device 200 may select a ratio of a length “a” of the screen 950 to a length “b” of the logo 960 as the detailed identification reference.

The device 200 according to an embodiment may determine a candidate object corresponding to the object 900 from among the plurality of candidate objects, based on the selected detailed identification reference, thereby identifying the object 900. Accordingly, the device 200 may select at least one smart TV from among the smart TVs of the group 901 classified based on the shape of the screen, based on information 220 about the identified object 900.

The device 200 according to an embodiment may display both the information 220 about the identified object 900 and an image 210 including an object on the screen of the device 200.

Only when there are a plurality of candidate objects, the device 200 according to an embodiment may additionally apply the detailed identification reference, thereby reducing the number of operations necessary for identifying an object. In order to increase an accuracy of an object identification result, the device 200 according to another embodiment may additionally apply the detailed identification reference even when there is one candidate object, thereby verifying whether the object identification result is appropriate.

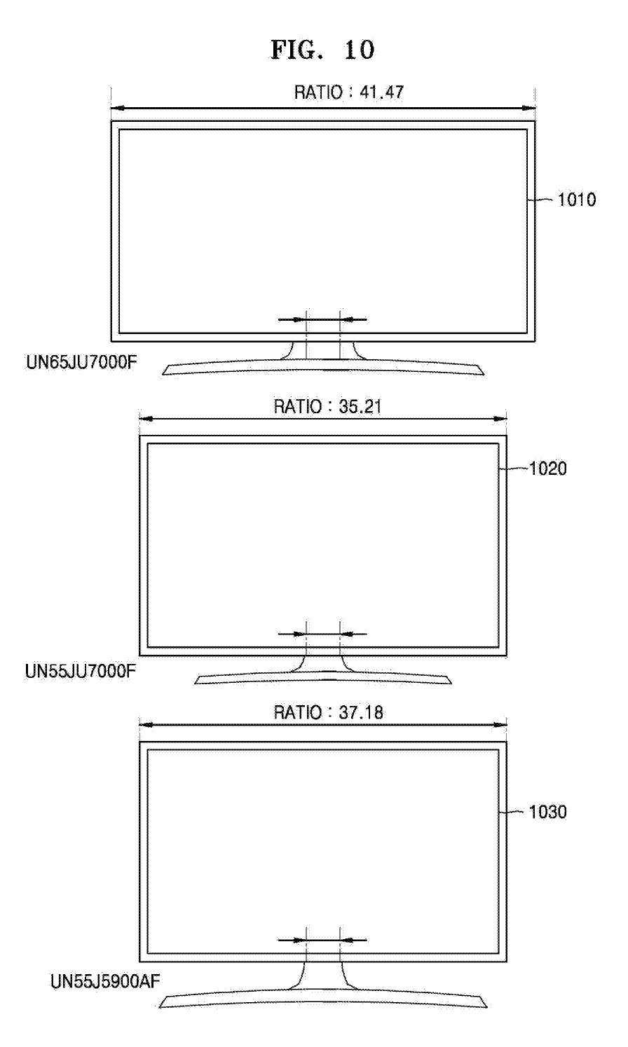

FIG. 10 is a diagram illustrating an example method of identifying, by a device, an object classified as a smart TV, based on a detailed identification reference, according to an example embodiment of the present disclosure.

Referring to FIG. 10, as a kind of an object is determined as a smart TV, the device may apply an identification reference corresponding to the smart TV to an image including the object to identify the object. When there are a plurality of candidate objects predicted as the object as a result of the identification, the device according to an embodiment may apply a detailed identification reference to the image including the object, for selecting one candidate object from among the plurality of candidate objects.

For example, in smart TVs, the device may select a ratio of a logo length to a screen length as a detailed identification reference. Therefore, the device may calculate a ratio of a logo length to a screen length in each of a first candidate object 1010, a second candidate object 1020, and a third candidate object 1030. As a result of the calculation, the device may check that the first candidate object 1010, the second candidate object 1020, and the third candidate object 1030 are 41.47, 35.21, and 37.18 in a ratio of a logo length to a screen length, respectively.

The device according to an embodiment may identify the first candidate object 1010, which is the highest in degree to which a ratio of a logo length to a screen length of a photographed object matches that of another object, as an object from among the plurality of candidate objects.

The device according to an embodiment may apply the detailed identification reference to an image including an object, and when an object is identified as a result of the application, the device may display information about the identified object on the screen of the device.

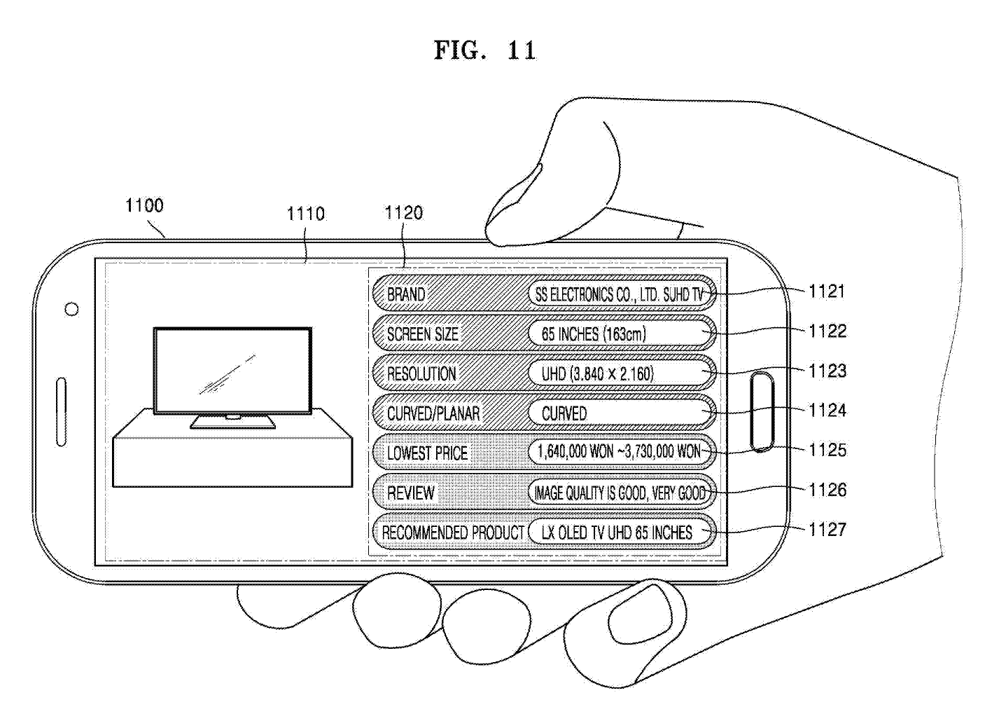

FIG. 11 is a diagram illustrating an example method of displaying, by a device 1100, information 1120 about an identified object on an image 1110 including the object, according to an example embodiment of the present disclosure.

Referring to FIG. 11, the device 1100 may identify an object, based on the image 1110 including the object. Here, a method of identifying, by the device 1100, an object based on the image 1110 including the object may correspond to the method described above with reference to FIGS. 1 to 10.

The information 1120 about the identified object according to an embodiment may include brand information 1121 about the object which is released. Also, the information 1120 about the identified object may include performance information which includes screen size information 1122, resolution information 1123, and screen shape information 1124. Also, the information 1120 about the identified object may include price information 1125 about the object and reaction (review) information 1126 about a user using the object. Also, the information 1120 about the identified object may include information 1127 about another object which has performance or a price similar to that of the identified object.

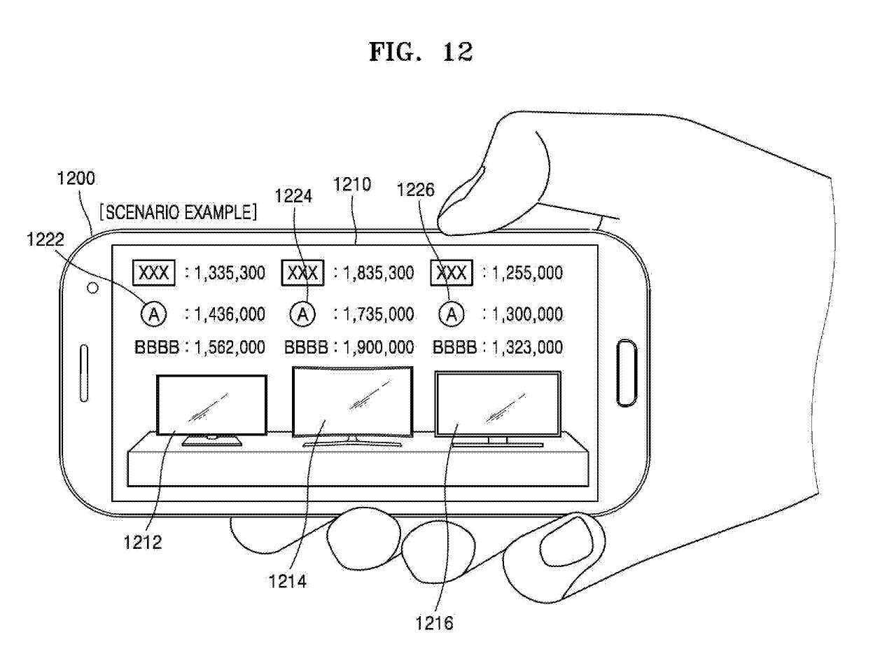

FIG. 12 is a diagram illustrating an example method of displaying, by a device 1200, pieces of information 1222, 1224, and 1226 about a plurality of objects 1212, 1214, and 1216 on an image 1210 including the plurality of objects 1212, 1214, and 1216, according to an example embodiment of the present disclosure.

Referring to FIG. 12, the device 1200 may identify each of the plurality of objects 1212, 1214, and 1216, based on the image 1210 obtained by photographing the plurality of objects 1212, 1214, and 1216. The device 1200 according to an embodiment may recognize each of the plurality of objects 1212, 1214, and 1216 in the image 1210. For example, the device 1200 may detect a contour of each of the plurality of objects 1212, 1214, and 1216 included in the image 1210 to recognize each of the plurality of objects 1212, 1214, and 1216.

Moreover, the device 1200 may determine what kind of object is each of the plurality of objects 1212, 1214, and 1216, based on the detected contour. As the kind of each of the plurality of objects 1212, 1214, and 1216 is determined, the device 1200 may identify each of the plurality of objects 1212, 1214, and 1216, based on an identification reference corresponding to the determined kind of the object. Here, a method of identifying, by the device 1200, each of the plurality of objects 1212, 1214, and 1216 may correspond to the method described above with reference to FIGS. 1 to 10.

As each of the plurality of objects 1212, 1214, and 1216 is identified, the device 1200 according to an embodiment may display the pieces of information 1222, 1224, and 1226 about the plurality of objects 1212, 1214, and 1216 on a screen of the device 1200. For example, the device 1200 may display the information 1222 about a first object 1212 within a predetermined distance range from the first object 1212 in the image 1210 displayed on the screen of the device 1200. Also, the device 1200 may display the information 1224 about a second object 1214 within a predetermined distance range from the second object 1214 in the image 1210 displayed on the screen of the device 1200. Also, the device 1200 may display the information 1226 about a third object 1216 within a predetermined distance range from the third object 1216 in the image 1210 displayed on the screen of the device 1200.

The device 1200 according to an embodiment may display information (for example, 1222) about an object (for example, 1212) near the object (for example, 1212) in an image (for example, 1210) including an object, thereby notifying a user that the displayed information (for example, 1222) is information about the object (for example, 1212).

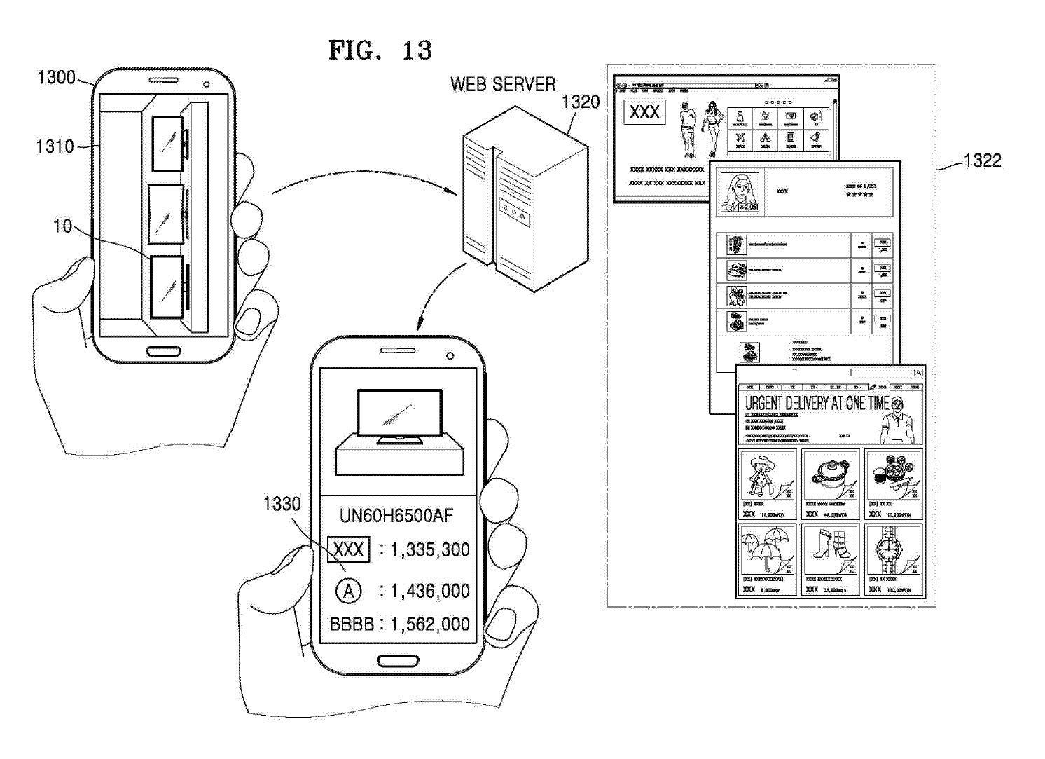

FIG. 13 is a diagram illustrating an example method of receiving, by a device 1300, information 1330 about an identified object from an external server 1320, according to an embodiment.

Referring to FIG. 13, the device 1300 may obtain an image 1310 including an object. The device 1300 according to an embodiment may analyze a shape of an object 10 based on the image 1310 including the object to determine a kind of an object corresponding to the object 10 as a smart TV. Also, the device 1300 may select an identification reference corresponding to the smart TV from among identification references which are previously set in the device 1300. Therefore, the device 1300 may identify the object, based on the selected identification reference such as a stand shape, a bezel shape, a screen shape, and a logo.

The device 1300 according to an embodiment may identify the object 10 as an A-10 smart TV released from S company as a result of the analysis, based on the identification reference corresponding to the smart TV. The device 1300 according to an embodiment may receive information about the identified object from the external server. For example, the device 1300 may receive price information and performance information, disclosed on webpages 1322 respectively provided from online shopping malls that sell the object 10, from the external server (for example, a web server 1320). However, this is merely an example embodiment, and the device 1300 may receive the information about the identified object from the external server that provides an SNS.

The device 1300 according to an embodiment may display the received information 1330 on a screen of the device 1300. For example, the device 1300 may display price information, provided from each of the online shopping malls that sell the object 10, on the screen of the device 1300.

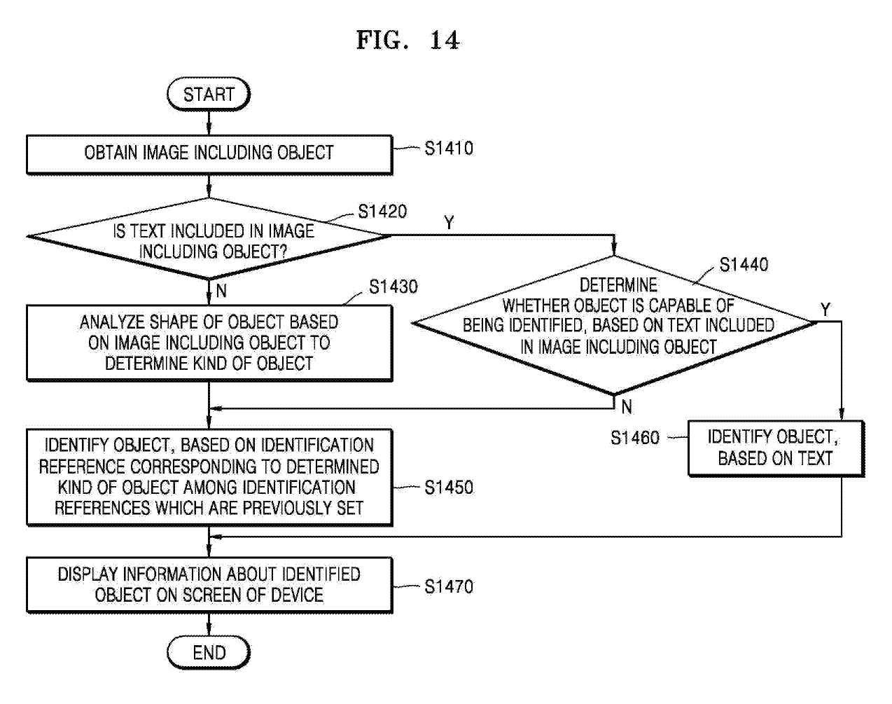

FIG. 14 is a flowchart illustrating an example method of identifying, by a device, an object when a text is included in an image including the object, according to an example embodiment of the present disclosure.

In operation S1410, the device may obtain an image including an object.

The device according to an embodiment may photograph the object to obtain the image including the object. According to another embodiment, the device may receive the image including the object from an external device.

In operation S1420, the device may determine whether text is included in the image including the object.

The device according to an embodiment may recognize a contour of the object from the image including the object to determine a location of the object. Also, the device may determine whether the text is located within a predetermined distance range from the determined location of the object.

In operation S1430, the device may analyze a shape of the object based on the image including the object to determine what kind of object it is.

When the text is not included in the image including the object, the device according to an embodiment may analyze the shape of the object, based on the recognized contour of the object. Also, device may analyze the shape of the object to the kind of the object.

In operation S1440, the device may determine whether the object is capable of being identified, based on the text included in the image including the object.

When the text is included in the image including the object, the device according to an embodiment may determine whether the object is capable of being identified, based on the text. For example, the device may identify the text included in the image including the object, based on text identifying technology such as OCR. The device may compare the identified text with identification information about the object which is previously stored in the device, thereby determining whether there is identification information about a corresponding object. According to another embodiment, the device may transmit the identified text to a web server, thereby determining whether there is an object corresponding to the identified text.

In operation S1450, the device may identify the object, based on an identification reference corresponding to the determined kind of the object from among a plurality of identification references which are previously set.

When it is determined that the object cannot be identified based on the text, the device according to an embodiment may identify the object, based on the identification reference corresponding to the kind of the object.

In operation S1460, the device may identify the object, based on the text.

It is determined in operation S1440 that the object is capable of being identified based on the text, the device according to an embodiment may identify the object, based on the text.

In operation S1470, the device may display the information about the identified object on a screen of the device.

Operation S1470 may correspond to operation S130 described above with reference to FIG. 1.

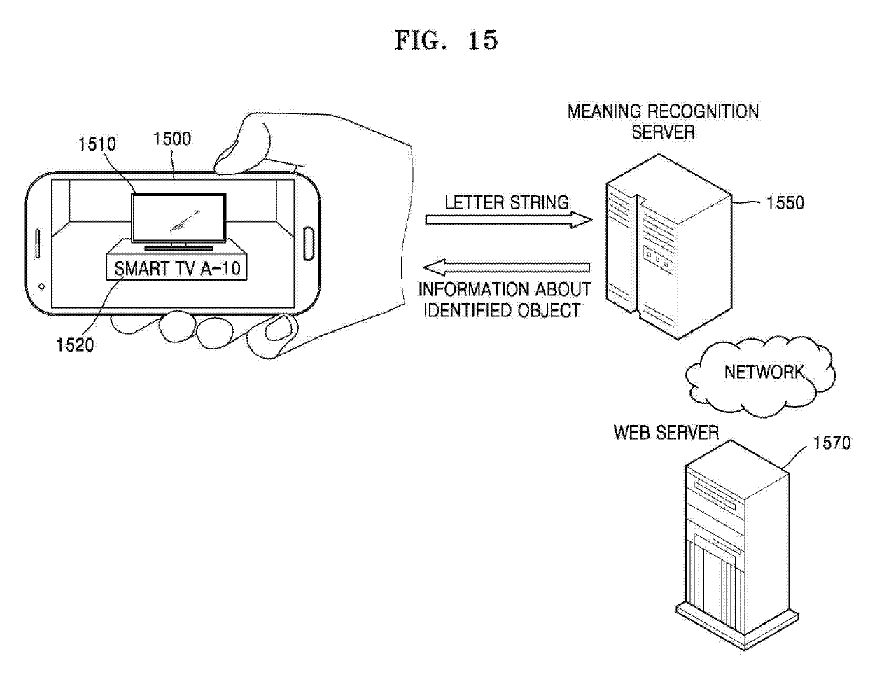

FIG. 15 is a diagram illustrating an example method of identifying, by a device 1500, an object based on a letter string 1520 included in an image 1510 including the object, according to an example embodiment of the present disclosure.

Referring to FIG. 15, the device 1500 according to an embodiment may obtain the image 1510 including an object. Also, the device 1500 may recognize a contour of the object in the image 1510 including the object to determine a location of the object. As the location of the object is determined in the image 1510 including the object, the device 1500 according to an embodiment may determine whether the letter string 1520 is located within a predetermined distance range with respect to the location of the object.

When the letter string 1520 is included in the image 1510 including the object, the device 1500 according to an embodiment may detect the letter string 1520 by using technology such as OCR. Here, the letter string 1520 may include object identification information including performance information and price information about the object.

The device 1500 according to an embodiment may transmit the letter string 1520 including the object identification information to an external meaning recognition server 1550. The meaning recognition server 1550 according to an embodiment may detect the object identification information from the letter string 1520 received from the device 1500 using a pre-stored meaning recognition model. Here, the meaning recognition model may store object identification information about each of a plurality of objects. The meaning recognition server 1500 may compare object identification information included in an obtained letter string with pre-stored identification information to select object identification information which is probabilistically the highest in possibility. The meaning recognition server 1500 may identify an object included in an image obtained from the device 1500, based on the selected object identification information.

The meaning recognition server 1550 may request information about the identified object from a web server 1570. For example, the meaning recognition server 1550 may request lowest price information about the identified object and reaction information about a user using the identified object from the web server 1570. When the information about the identified object is received from the web server 1570 in response to the request, the meaning recognition server 1550 may transmit the information about the identified object to the device 1500.

The device 1500 according to an embodiment may display the information about the identified object, which is received from the meaning recognition server 1550, on a screen of the device 1500.

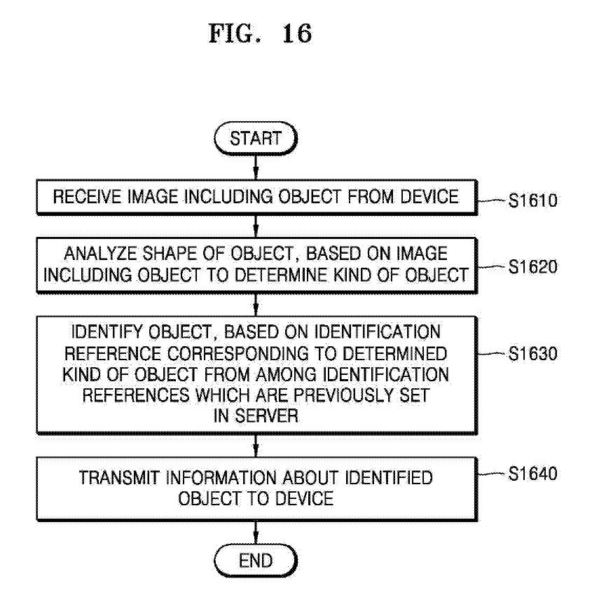

FIG. 16 is a flowchart illustrating an example method of providing, by a server, information about an object, according to an example embodiment of the present disclosure.

In operation S1610, the server may receive an image including an object from a device.

The server according to an embodiment may receive an image, generated by a device photographing an object, from the device. According to another embodiment, the server may receive an image including an object which the device has obtained from an external device.

In operation S1620, the server may analyze a shape of the object based on the image including the object to determine what kind of object it is.

The server according to an embodiment may analyze a shape of the object in the image including the object. For example, the server may recognize a contour of the object in the image including the object. Also, when a plurality of objects are displayed on the image including the object, the server may select an object which is located in a certain area such as a center portion, and may analyze a shape of the selected object.

The server according to an embodiment may determine what kind of object is the object, based on a result of the analysis of the shape of the object. For example, when the shape of the object is recognized from the image including the object, the server may compare the recognized shape of the object with shapes of a plurality of kinds of objects which are previously stored. Also, the server may calculate a degree to which the recognized shape of the object matches the shape of each of the plurality of kinds of objects which are previously stored, thereby determining what kind of object is the recognized object.

In operation S1630, the server may identify an object, based on an identification reference corresponding to the determined kind of the object from among a plurality of identification references which are previously set in the server.

The server according to an embodiment may previously set an identification reference for each of kinds of a plurality of objects. For example, the server may previously set an identification reference for a smart TV to a stand shape, a bezel shape, a screen shape, and a logo.

The server according to an embodiment may select an identification reference corresponding to a kind of an object from among identification references which are previously set for kinds of a plurality of objects. Also, the server may identify the object, based on the selected identification reference. For example, when the kind of the object is determined as a smart TV, the server may identify the object, based on a stand shape, a bezel shape, a screen shape, and a logo which are identification references corresponding to the smart TV.

In operation S1640, the server may transmit information about the identified object to a device.

As the object is identified, the server according to an embodiment may obtain the information about the identified object. Here, the information about the identified object may include price information and performance information about the object and reaction information about a user using the object, but this is merely an example embodiment. The information about the identified object is not limited to the above-described example.

Moreover, the server may receive the information about the identified object from an external server. For example, the server may receive the price information and performance information about the identified object from an online shopping mall server that provides a service for selling the identified object. According to another embodiment, the server may receive user reaction information, including a review about the identified object, from an SNS server.

The server according to an embodiment may transmit the information about the identified object to the device. Therefore, the device may display the information about the identified object on a screen of the device.

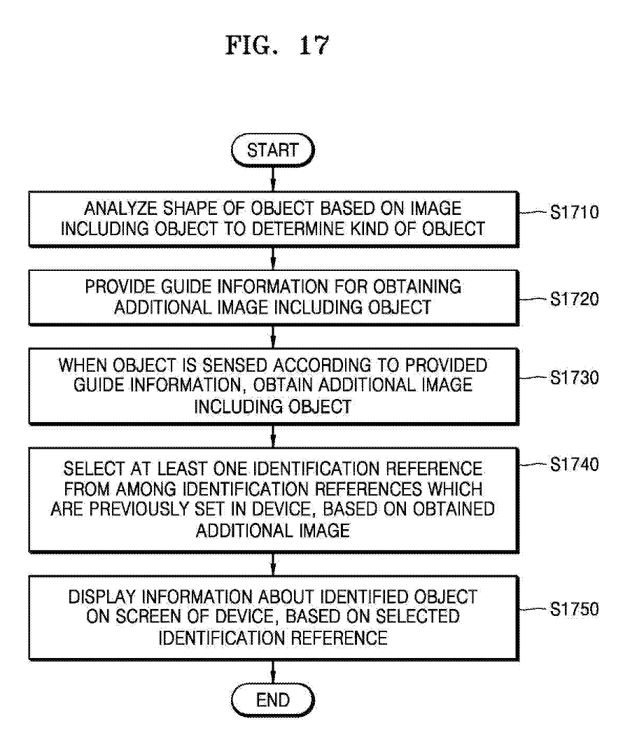

FIG. 17 is a flowchart illustrating an example method of providing, by a device, information about an identified object based on an obtained additional image according to guide information being provided, according to an example embodiment of the present disclosure.

In operation S1710, the device may analyze a shape of an object, based on an image including the object, thereby determining the kind of object.

The device according to an embodiment may analyze the shape of the object in the image including the object. The device according to an embodiment may determine the kind of the object, based on a result of the analysis of the shape of the object.

In operation S1720, the device may provide guide information for obtaining an additional image including the object.

The device according to an embodiment may determine whether at least one identification reference is capable of being selected from among a plurality of identification references which are previously set, based on the image including the object. For example, the device may determine whether an identification reference for identifying the object is capable of being selected from among the plurality of identification references, based on a size and a location of the object in the image and the quality of the image.

When it is determined that obtaining of the additional image including the object is needed, the device according to an embodiment may provide the guide information for obtaining the additional image. For example, the device may provide voice guide information that requests the proximity photographing of the object, or may provide image guide information that requests photographing in order for the object to be located in a center of the additional image.

In operation S1730, when the object is sensed according to the provided guide information, the device may obtain the additional image including the object.

The device according to an embodiment may determine whether the object is sensed, based on the provided guide information. For example, when the voice guide information that requests the proximity photographing of the object is provided, the device may determine whether the object is sensed in a certain size or more. According to another embodiment, in photographing an object, when focus control is requested, the device may determine whether the device may determine whether the object is sensed in correspondence with the requested focus.

As the object is sensed in correspondence with the provided guide information, the device according to an embodiment may obtain the additional image including the object. For example, as the object is sensed in a certain size or more, the device may obtain the additional image including the object. According to another embodiment, as object is sensed in correspondence with the requested focus, the device may obtain the additional image including the object.

In operation S1740, the device may select at least one identification reference from among a plurality of identification references which are previously set in the device, based on the obtained additional image.

The device according to an embodiment may analyze in detail the shape of the object with reference to the obtained additional image to select an identification reference for identifying the object from another object, based on the determined kind of the object. For example, when the object is identified as a smart TV including a planar screen by using the additional image, the device may select a stand shape, which enables the smart TV including the planar screen to be identified, as an identification reference.

The device according to an embodiment may more accurately select an identification reference for identifying the object from another object, based on information about a portion of the object, recognized through the obtained additional image, as well as a kind of the object.

In operation S1750, the device may display the information about the identified object on a screen of the device, based on the selected identification reference.

The device according to an embodiment may identify the object, based on the selected identification reference. Also, as the object is identified, the device may obtain the information about the identified object.

The device according to an embodiment may display the information about the identified object within a predetermined distance range from a location at which the object is displayed on the screen of the device. For example, when the image including the object is being displayed on the screen of the device, the device may display at least one of price information and performance information about the identified object and user reaction information within a predetermined distance range from a location of the object in the displayed image.

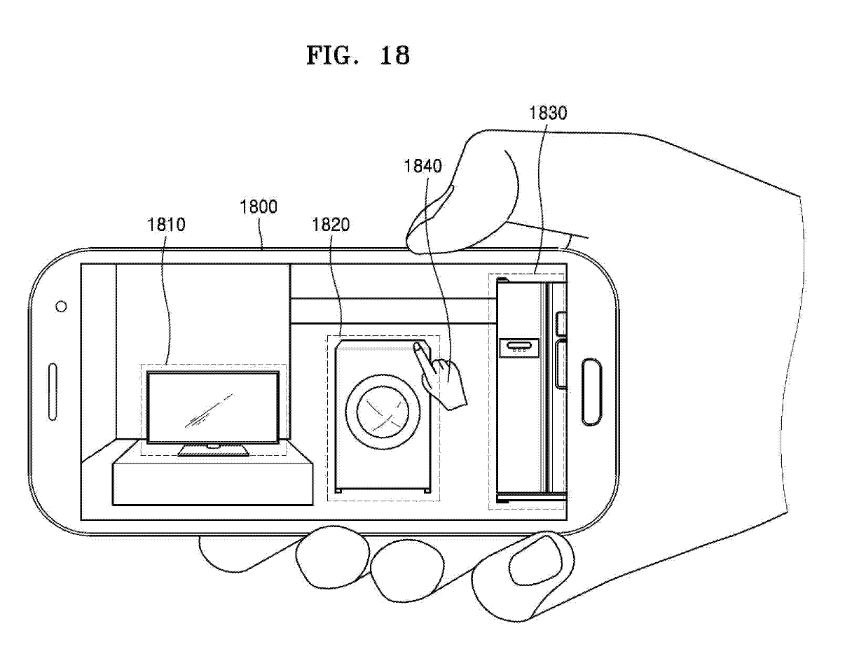

FIG. 18 is a diagram illustrating an example method of selecting, by a device 1800, one object from among a plurality of objects included in an image, based on a user input, according to an example embodiment of the present disclosure.

When a user requests information about an object, the device 1800 according to an embodiment may recognize at least one object using an image sensor included in the device 100. For example, the device 1800 may sense a first object 1810, a second object 1820, and a third object 1830 which are sensed by the image sensor of the device 1800.

When a plurality of objects (for example, 1810, 1820, and 1830) are sensed, the device 1800 according to an embodiment may provide a user interface for selecting at least one of the sensed plurality of objects 1810, 1820, and 1830. For example, the device 1800 may display a target box for each of the sensed plurality of objects 1810, 1820, and 1830. The target box is merely an example, and the device 1800 may mark an identification mart, such as highlight, a dotted line, and/or the like, on each of the sensed plurality of objects 1810, 1820, and 1830.

Moreover, the device 100 may sense an input, for example, and without limitation, a user input 1840 received through the provided user interface to select the second object 1820 corresponding to the user interface 1840 from among the sensed plurality of objects 1810, 1820, and 1830. Here, the user input 1840 may include at least one of signals generated from a touch of a remote controller, a gesture, eye-gaze trace, a voice, and an input tool (for example, a remote controller, a smartphone, or the like).

According to another embodiment, the device 1800 may select at least one object from among the plurality of objects 1810, 1820, and 1830 included in an image displayed on a screen of the device 1800. Also, the device 1800 may mark an identification mark, such as a target box and/or the like, on the selected object (for example, the second object 1820). However, this is merely an example embodiment, and the device 1800 may mark an identification mark on a nearby object located within a certain range from the selected object (for example, the second object 1820). Therefore, the user may check whether an object desired by the user is selected based on a user input.

Moreover, when two or more objects are selected based on a user input, the device 1800 may issue a request to select one object from among the selected two or more objects. For example, when two or more objects are selected, the device 1800 may output a message or a voice command which requests a selection of one of the selected two or more objects.

The device 1800 according to an embodiment may identify the selected second object 1820 according to the method described above with reference to FIG. 17, and may display information about the identified second object 1820 on the screen of the device 1800.

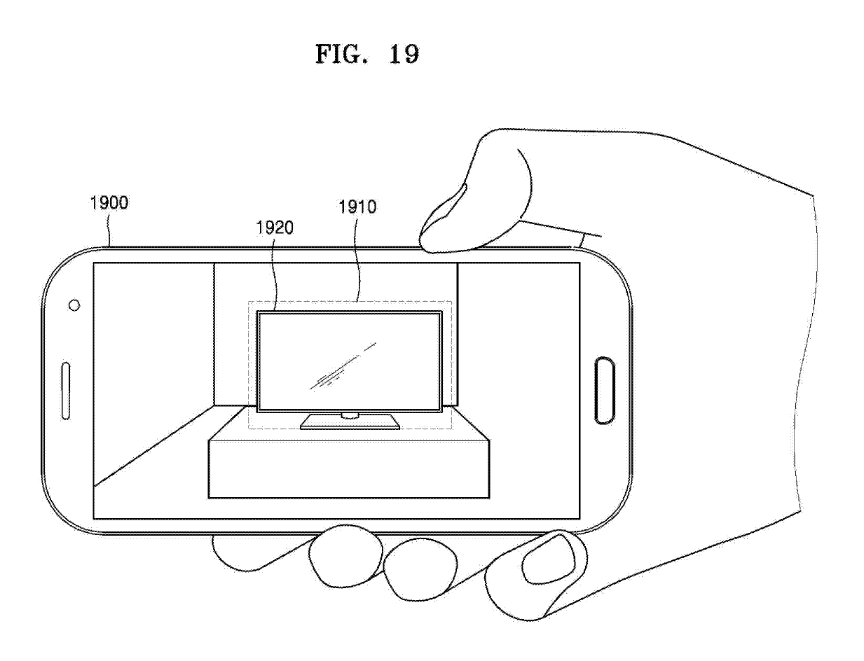

FIG. 19 is a diagram illustrating an example method of selecting, by a device 1900, an object 1920 from an image including the object 1910, according to an example embodiment of the present disclosure.

When at least one image is obtained, the device 1900 according to an embodiment may determine whether there is an object located in a predetermined area of the obtained image. For example, the device 1900 may determine whether the object 1920 is located in a center area 1910 of the image.

When a plurality of objects are included in the image, the device 1900 according to an embodiment may select an object located in a predetermined area from among the plurality of objects. The device 1900 may determine what kind of object is the selected object. Also, the device may select an identification reference for identifying the object from the other objects, based on the determined kind of the object. The device 1900 may identify the object, based on the selected identification reference and may display information about the identified object on a screen of the device 1900.

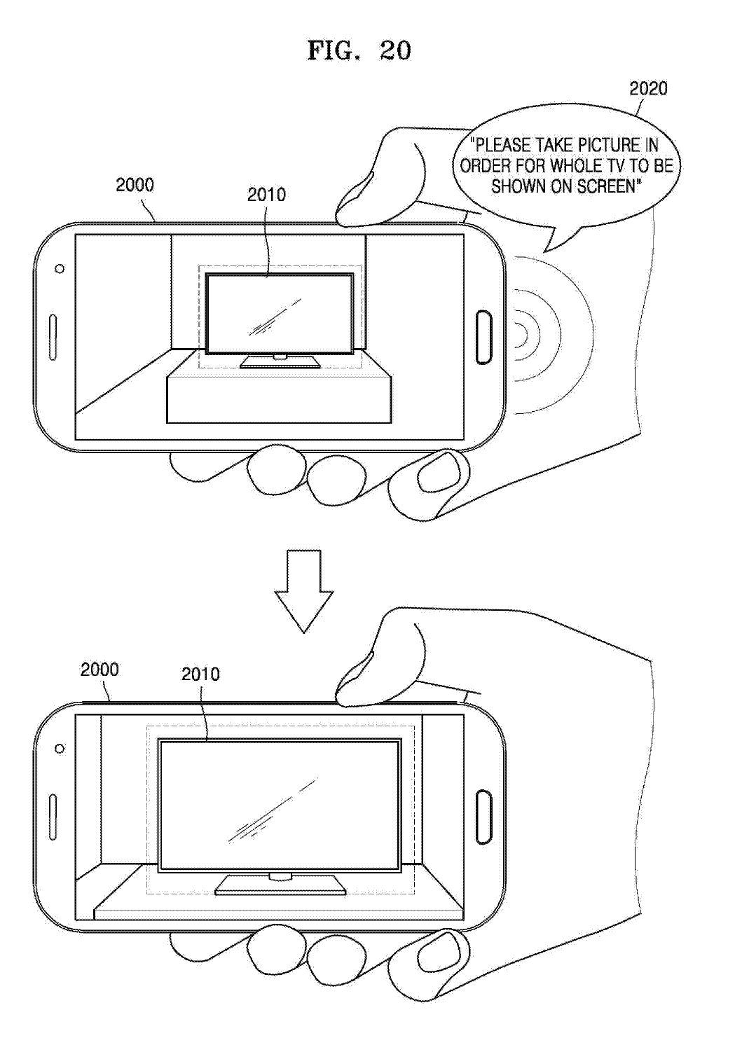

FIG. 20 is a diagram illustrating an example method of providing, by a device 2000, voice guide information, according to an example embodiment of the present disclosure.

Referring to FIG. 20, the device 2000 may determine that since a size of an object 2010 included in an image is smaller than a predetermined reference, it is difficult to provide information necessary to select an identification reference for identifying the object 2010.

Therefore, the device 2000 may provide guide information for obtaining additional image including an object. For example, the device 2000 may output a voice message “please take a picture in order for a whole TV to be shown on a screen” 2020. As the voice message 2020 is output, a user of the device 2000 may change a location of the device 2000 or a distance between the device 2000 and the object to obtain the additional image including the object, based on the guide information.

Moreover, when it is determined that it is difficult to obtain information necessary for selecting an identification reference for the object 2010, as disclosed in FIG. 20, the device 2000 may enlarge an obtained image to generate an additional image. For example, the device 2000 may enlarge an image of an obtained object by using a super resolution (SR) technique. The device 2000 may enlarge an image including an object and may analyze a shape of the object, thereby increasing an object recognition rate.

The device 2000 according to an embodiment may analyze in more detail a shape of the object from the obtained additional image to select an identification reference for identifying the object from other objects, based on a determined kind of the object. Also, the device 2000 may display information about the identified object on a screen of the device 2000, based on the selected identification reference.

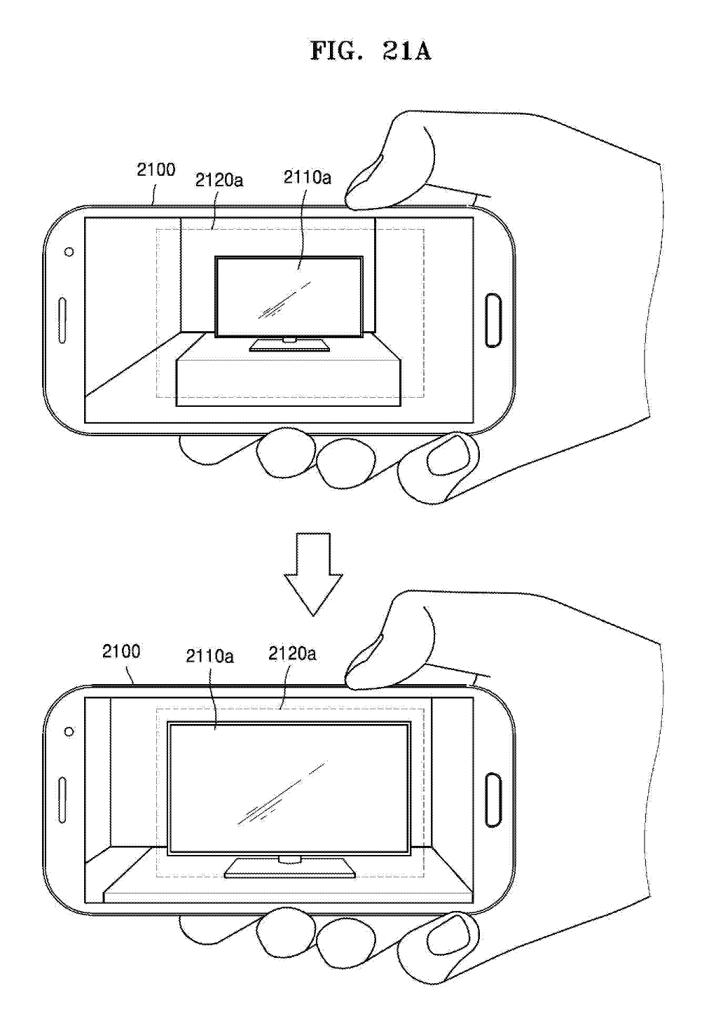

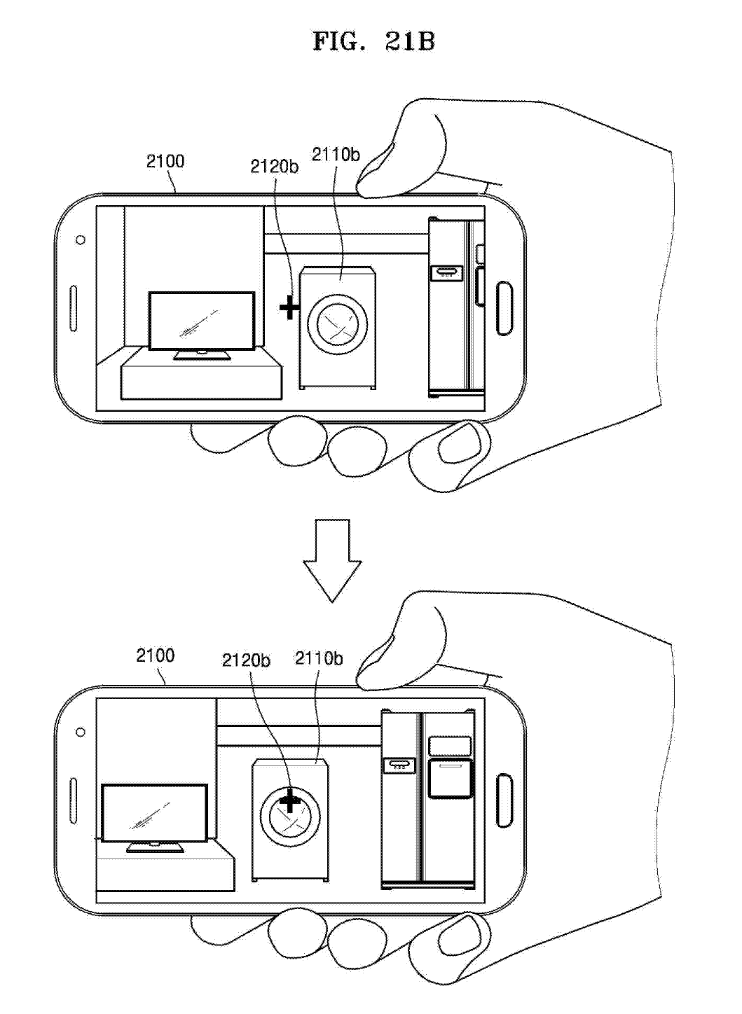

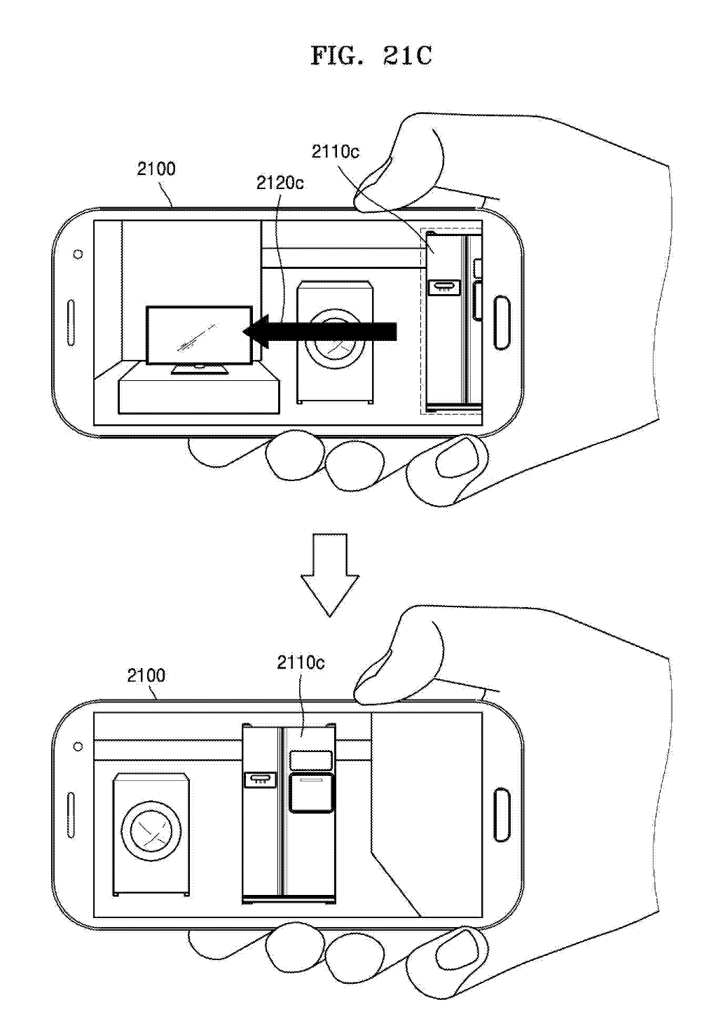

FIGS. 21A, 21B and 21C are diagrams illustrating an example method of providing, by a device 2100, image guide information, according to an example embodiment of the present disclosure.

Referring to FIG. 21A, when a whole portion of an object 2110a is included in an image, the device 2100 may determine that information necessary to select an identification reference for identifying the object 2110a is not provided from the image.

The device 2100 according to an embodiment may provide image guide information for obtaining an additional image used to select an identification reference. For example, the device 2100 may display a frame 2120a, which is to be matched with the object 2110a, on a screen of the device 2100. As the frame 2120a is displayed, a user of the device 2100 may adjust a location of the device 2100 and a distance between the device 2100 and the object 2110a so that the object 2110a is located in the displayed frame 2120a. As the object 2110a in the frame 2120a is recognized, the device 2100 may obtain an additional image including the object 2110a.

Referring to FIG. 21B, the device 2100 may provide image guide information for obtaining an additional image used to select an identification reference. For example, the device 2100 may display focus information 2120b, representing information about where the object 2110b is located in the image, on the screen of the device 2100. As the focus information 2120b is displayed, the user of the device 2100 may adjust the location of the device 2100 and the distance between the device 2100 and the object 2110b so that the object 2110b is located at a location corresponding to the focus information 2120b. As a focus mark being located in a center of the object 2110b is recognized, the device 2100 may obtain an additional image including the object 2110b.

Referring to FIG. 21C, the device 2100 may provide image guide information for obtaining an additional image used to select an identification reference. For example, the device 2100 may display guide information 2120c for requesting a location change of the device 2100 so that a whole portion of the object 2110c is included in the screen of the device 2100. As the guide information 2120c for requesting the location change of the device 2100 is displayed, the user of the device 2100 may change the location of the device 2100 so that the whole portion of the object 2110c is included in the screen of the device 2100. As the whole portion of the object 2110a is included in the screen of the device 2100, the device 2100 may obtain an additional image including the object 2110c.

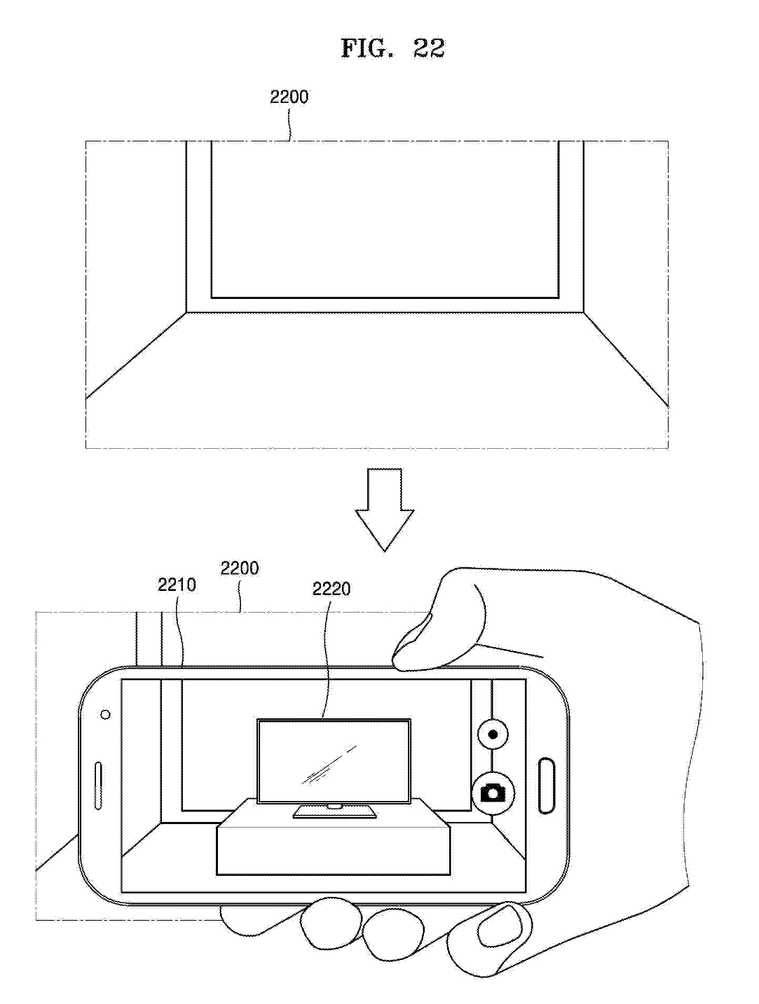

FIG. 22 is a diagram illustrating an example method of providing, by a device 2210, information about an identified object, according to an example embodiment of the present disclosure.

When an object is identified, the device 2210 according to an embodiment may display information about the identified object on a screen of the device 2210.

Referring to FIG. 22, the device 2210 may display information about at least one of previously identified objects on a space 2200 recognized by an image sensor of the device 2210. For example, when a user obtains an A smart TV, the device 2210 may synthesize an image of the A smart TV with the space 2200 recognized by the device 2210 to display the synthesized image on the screen of the device 2210.

The device 2210 according to an embodiment may recognize a space requested by the user, synthesize an image of the recognized space and an image of the identified object, and display an image 2220 obtained through the synthesis on the screen of the device 2210. The user may more easily determine whether to purchase the object, based on the image 2220.

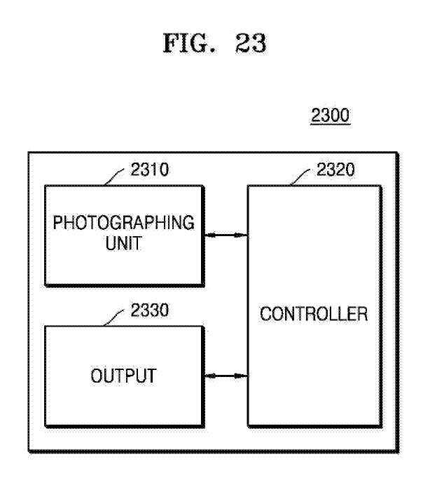

FIG. 23 is a block diagram illustrating an example device 2300 for providing information about an identified object, according to an example embodiment of the present disclosure.

Referring to FIG. 23, the device 2300 according to an embodiment may include a photographing unit (e.g., including a camera) 2310, a controller (e.g., including processing circuitry) 2320, and an output (e.g., including output circuitry) 2330. However, all of the elements are not essential elements. The device 2300 may be implemented by more elements than the number of illustrated elements. Alternatively, the device 2300 may be implemented by fewer elements than the number of illustrated elements.

The photographing unit 2310 according to an embodiment may include, for example, and without limitation, a camera to photograph an object to obtain an image including the object. However, this is merely an example embodiment. In other embodiments, if a communicator (not shown) or an input unit (not shown) is included in the device 2300, the device 2300 may obtain the image including the object from an external device.

The controller 2320 according to an embodiment may include various processing circuitry to analyze a shape of the object based on the image including the object to determine what kind of object it is. The controller 2320 may analyze the shape of the object in the image including the object. For example, the controller 2320 may recognize a contour of the object in the image including the object. Also, when a plurality of objects are displayed on the image including the object, the controller 2320 may select an object located in a certain area such as a center portion of the image and may analyze a shape of the selected object.

The controller 2320 according to an embodiment may determine what kind of object is the object, based on a result of the analysis of the shape of the object. For example, when the controller 2320 recognizes the shape of the object from the image including the object, the controller 2320 may compare the recognized shape of the object with shapes of a plurality of kinds of objects which are previously stored. Also, the controller 2320 may calculate a degree to which the recognized shape of the object matches the shape of each of the plurality of kinds of objects which are previously stored, thereby determining what kind of object is the recognized object.

The controller 2320 according to an embodiment may identify an object, based on an identification reference corresponding to the determined kind of the object from among a plurality of identification references which are previously set in the device 2300. Here, the controller 2320 may previously set an identification reference for each of a plurality of objects.

The controller 2320 according to an embodiment may select an identification reference corresponding to a kind of an object from among identification references which are previously set for kinds of a plurality of objects. Also, the controller 2320 may identify the object, based on the selected identification reference.

The output 2330 according to an embodiment may include various output circuitry to display information about the identified object on the screen of the device 2300. For example, the device 2300 may receive information about the identified object through a communicator (not shown) from an external server. However, this is merely an example embodiment, and the device 2300 may detect the information about the identified object from among pieces of information about a plurality of objects which are previously stored in the device 2300. The output unit 2330 may display the information about the identified object within a predetermined distance range from a location at which the object is displayed on the screen of the device 2300.

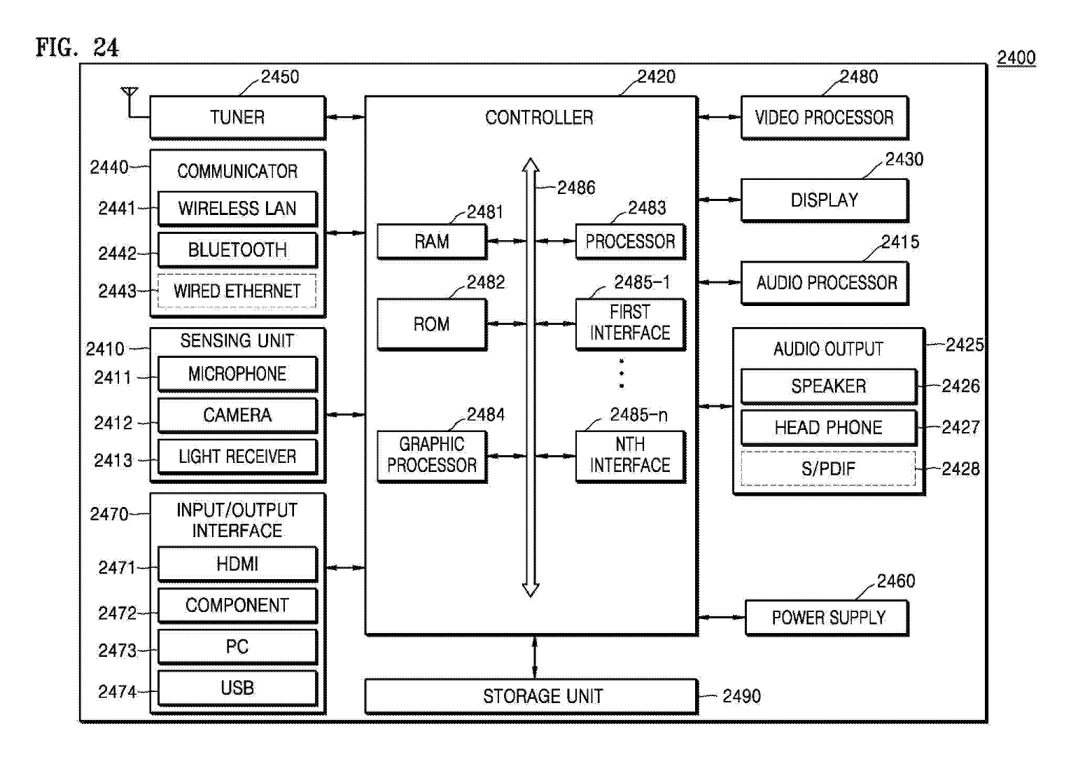

FIG. 24 is a block diagram illustrating an example device 2400 for providing information about an identified object, according to another example embodiment of the present disclosure.

Referring to FIG. 24, the device 2400 according to an embodiment may include a sensing unit 2410, an audio processor 2415, a controller (e.g., including processing circuitry) 2420, an audio output 2425, a display 2430, a communicator (e.g., including communication circuitry) 2440, a tuner 2450, a power supply 2460, an input/output interface (e.g., including input/output circuitry) 2470, an video processor 2480, and a storage unit 2490.

Hereinafter, the elements will be described in order.

The sensing unit 2410 according to an embodiment may include various sensing circuitry, such as, for example, and without limitation, a microphone 2411, a camera 2412, and a light receiver 2413.

The microphone 2411 may receive a voice uttered by a user. The microphone 2411 may convert the received voice into an electrical signal and may output the electrical signal to the controller 2420.

The microphone 2411 may be implemented as an integrated type or a removable type. The detached microphone 2411 may be electrically connected to the device 2400 through the communicator 2440 or the input/output unit 2470. It can be easily understood by one of ordinary skill in the art that the microphone may be omitted depending on the performance and structure of the device 2400.

The camera 2412 may convert a received image into an electrical signal according to control by the controller 2420 and may output the electrical signal to the controller 2420. The camera 2412 according to an embodiment may correspond to the photographing unit 1710 described above with reference to FIG. 17.

The light receiver 2413 may receive a light signal (including a control signal) from an external input device through a light window (not shown) of a bezel of the display 2430. The light receiver 2413 may receive a light signal corresponding to a user input (for example, a touch, push, a touch gesture, a voice, or a motion) from the input device. The control signal may be extracted from the received light signal according to control by the controller 2420.

The controller 2420 may include various processing circuitry to control an overall operation of the device 2400. For example, the controller 2420 may execute programs stored in the storage unit 2490 to overall control the sensing unit 2410, the display 2430, the audio processor 2415, the audio output 2425, the communicator 2440, the tuner 2450, the power supply 2460, the input/output interface 2470, the video processor 2480, and the storage unit 2490.

The controller 2420 may correspond to the controller 1720 described above with reference to FIG. 17.

The display 2430 may convert an image signal, a data signal, an OSD signal, or a control signal obtained through processing by the controller 2420 to generate a driving signal. The display 2430 may be implemented with a plasma panel display (PDP), a liquid crystal display (LCD), an organic light-emitting diode (OLED), a flexible display, or the like, but is not limited thereto. Also, the display 2430 may be implemented with a three-dimensional (3D) display. Also, the display 2430 may be configured with a touch screen and may be used as an input device in addition to an output device.

The display 2430 may correspond to the output unit 1730 described above with reference to FIG. 17.

The audio processor 2415 may include various circuitry to perform processing on audio data. The audio processor 2415 may perform various processing, such as decoding, amplification, noise filtering, etc., on the audio data. The audio processor 2415 may include a plurality of audio processing modules for processing audios corresponding to a plurality of content.

The audio output 2425 may include various circuitry to output an audio included in a broadcast signal received through the tuner 2450 according to control by the controller 2420. The audio output 2425 may output an audio (for example, a voice, a sound) which is input through the communicator 2440 or the input/output interface 2470. Also, the audio output 2425 may output an audio stored in the storage unit 2490 according to control by the controller 2420. The audio output 2425 may include various output circuitry, such as, for example, and without limitation, a speaker 2426, a head phone output terminal 2427, or a Sony/Philips digital interface (S/PDIF) output terminal 2428. The audio output 2425 may include a combination of the speaker 2426, the head phone output terminal 2427, and the S/PDIF output terminal 2428.

The communicator 2440 may include various communication circuitry to connect the device 2400 to an external device (for example, a web server, an SNS server, an online shopping mall server, or the like) according to control by the controller 2420. For example, the controller 2420 may receive information about an identified object through the communicator 2440. The communicator 2440 may include various communication circuitry, such as, for example, and without limitation, one or more of a wireless local area network (LAN) 111, Bluetooth 2442, and wired Ethernet 2443, based on the performance and structure of the device 2400. Also, the communicator 2440 may include a combination of the wireless local area network (LAN) 111, the Bluetooth 2442, and the wired Ethernet 2443.

The communicator 2440 may further include close-range communication (for example, near field communication (NFC)) and Bluetooth low energy (BLE) (not shown) in addition to the Bluetooth 2442.

The tuner 2450 may perform amplification, mixing, resonance, and/or the like on a broadcast signal received by wire or wirelessly to tune and select only a frequency of a channel, which is to be received by the display apparatus 100, among a number of radio wave components. The broadcast signal may include an audio, a video, and additional information (for example, electronic program guide (EPG).

The tuner 2450 may receive a broadcast signal in a frequency band corresponding to a channel number (for example, cable broadcast No. 506) according to a user input (for example, a control signal (for example, a channel number input, a channel up-down input, and a channel input based on an EPG screen) received from a control device).

The tuner 2450 may receive a broadcast signal from various sources such as terrestrial broadcast, cable broadcast, satellite broadcast, Internet broadcast, etc. The tuner 2450 may receive the broadcast signal from a source such as analog broadcast or digital broadcast. The broadcast signal received through the tuner 2450 may be decoded (for example, audio decoding, video decoding, or additional information decoding), and thus, may be separated into an audio, a video, and/or additional information. The audio, the video, and/or the additional information may be stored in the storage unit 2490 according to control by the controller 2420.

The power supply 2460 may supply power, input from an external power source, to internal elements of the device 2400 according to control by the controller 2420. Also, the power supply 2460 may supply power, output from one battery or two or more batteries provided in the device 2400, the internal elements according to control by the controller 2420.

The input/output interface 2470 may include various circuitry to receive a video (for example, a moving image, etc.), an audio (for example, a voice, music, etc.), and additional information (for example, EPG, etc.) from the outside of the device 2400 according to control by the controller 2420. The input/output interface 2470 may include various interface circuitry, such as, for example, and without limitation, one or more of a high-definition multimedia interface (HDMI) port 2471, a component jack 2472, a personal computer (PC) port 2473, and a universal serial bus (USB) port 2474. The input/output unit 2470 may include a combination of the HDMI port 2471, the component jack 2472, the PC port 2473, and the USB port 2474.

It can be understood by one of ordinary skill in the art that a configuration and an operation of the input/output interface 2470 may be variously implemented according to embodiments.

The video processor 2480 may perform processing on video data received by the device 2400. The video processing unit 2480 may perform various image processing, such as decoding, scaling, noise filtering, frame rate conversion, resolution conversion, etc., on the video data.

The controller 2420 may include a random access memory (RAM) 2481 which stores signals or data input from the outside of the device 2400 or is used as a storage area corresponding to each of various operations performed by the device 2400, a read-only memory (ROM) 2482 for controlling the device 2400, and a processor 2483.

The processor 2483 may include a graphic processing unit (GPU) (not shown) for graphic processing which corresponds to a video. The processor 2483 may be implemented with a system-on chip (SoC) where a core (not shown) and the GPU are integrated. The processor 2483 may include a single core, a dual core, a triple core, a quad core, and a core corresponding to a multiple thereof.

Moreover, the processor 2483 may include a plurality of processors. For example, the processor 2483 may be implemented with a main processor (not shown) and a sub-processor (not shown) which operates in a sleep mode).

The graphic processor 2484 may generate a screen including various objects such as an icon, an image, a text, and/or the like by using an operational unit (not shown) and a rendering unit (not shown). The operational unit may calculate attribute values, such as a coordinate value, a shape, a size, a color, and/or the like of each of objects which are to be displayed, based on a layout of a screen by using a user input sensed by the sensing unit 2410. The rendering unit may generate a screen having various layouts and including an object, based on the attribute values calculated by the operational unit. The screen generated by the rendering unit may be displayed on a display area of the display 2430.

First to nth interfaces 2485-1 to 2485-n may be connected to the above-described elements. One of the first to nth interfaces 2485-1 to 2485-n may be a network interface which is connected to an external device over a network.

The RAM 2481, the ROM 2482, the processor 2483, the graphic processing unit 2484, and the first to nth interfaces 2485-1 to 2485-n may be connected to each other through an internal bus 2486.

In the present embodiment, the term “controller” may include the RAM 2481, the ROM 2482, and the processor 2483.

The storage unit 2490 may store various data, programs, or applications for driving and controlling the device 2400 according to control by the controller 2420. For example, the storage unit 2490 may store a control program for controlling the control of the controller 2420 and the device 2400, an application which is initially provided by a manufacturer or is downloaded from the outside, a graphical user interface (GUI) associated with the application, an object (for example, an image text, an icon, a button, etc.) for providing the GUI, user information, documents, databases, relevant data, and/or the like.

In an embodiment, the term “storage unit” may include the storage unit 2490, the RAM 2481 and ROM 2482 of the controller 2420, or a memory card (for example, micro SD or a USB memory (not shown)) equipped in the device 2400. Also, the storage unit 2490 may include a non-volatile memory, a volatile memory, a hard disk drive (HDD), or a solid state drive (SSD).

Although not shown, the storage unit 2490 may include a broadcast reception module, a channel control module, a volume control module, a communication control module, a voice recognition module, a motion recognition module, a light reception module, a display control module, an audio control module, an external input control module, a power control module, a power control module of an external device wirelessly connected (for example, Bluetooth) to the device 2400, a voice database (DB), and a motion DB. The modules and DBs (not shown) of the storage unit 2490 may each be implemented as a software type for performing a control function for broadcast reception by the device 2400, a channel control function, a volume control function, a communication control function, a voice recognition function, a motion recognition function, a light reception control function, a display control function, an audio control function, an external input control function, a power control function, and a power control function of an external device wirelessly connected (for example, Bluetooth) to the device 2400. The controller 2420 may perform each of the functions by using the software stored in the storage unit 2490.

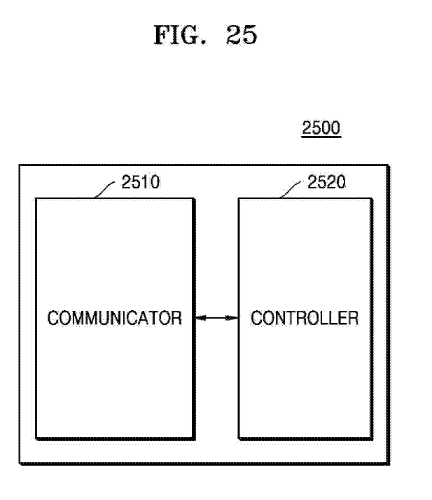

FIG. 25 is a block diagram illustrating an example server 2500 for providing information about an identified object, according to an example embodiment of the present disclosure.

Referring to FIG. 25, the server 2500 according to an embodiment may include a communicator (e.g., including communication circuitry) 2510 and a controller (e.g., including processing circuitry) 2320. However, all of the elements are not essential elements. The server 2500 may be implemented by more elements than the number of illustrated elements. Alternatively, the server 2500 may be implemented by fewer elements than the number of illustrated elements.

Hereinafter, the elements will be described in order.

The communicator 2510 may include various communication circuitry configured to receive an image including an object from a device.

The communicator 2510 according to an embodiment may receive an image, generated by a device photographing an object, from the device. According to another embodiment, the communicator 2510 may receive an image including an object which the device has obtained from an external device.

Moreover, the communicator 2510 may include various communication circuitry configured to transmit information about an identified object to the device. According to an embodiment, the device communicator 2510 may receive the information about the identified object from an external server. For example, the communicator 2510 may receive price information and performance information about the identified object from an online shopping mall server that provides a service for selling the identified object. According to another embodiment, the communicator 2510 may receive user reaction information, including a review about the identified object, from an SNS server.

The communicator 2510 according to an embodiment may transmit the information about the identified object to the device. Therefore, the device may display the information about the identified object on a screen of the device.

The controller 2520 may include various processing circuitry configured to analyze a shape of the object based on the image including the object to determine what kind of object it is. The controller 2520 according to an embodiment may analyze a shape of the object in the image including the object. For example, the controller 2520 may recognize a contour of the object in the image including the object. Also, when a plurality of objects are displayed on the image including the object, the controller 2520 may select an object located in a certain area such as a center portion of the image and may analyze a shape of the selected object.

The controller 2520 according to an embodiment may determine the kind of the object, based on a result of the analysis of the shape of the object. For example, when the controller 2520 recognizes the shape of the object from the image including the object, the controller 2520 may compare the recognized shape of the object with shapes of a plurality of kinds of objects which are previously stored. Also, the controller 2520 may calculate a degree to which the recognized shape of the object matches the shape of each of the plurality of kinds of objects which are previously stored, thereby determining what kind of object is the recognized object.

The controller 2520 according to an embodiment may identify an object, based on an identification reference corresponding to the determined kind of the object from among a plurality of identification references which are previously set in the server. The controller 2520 may previously set an identification reference for each of kinds of a plurality of objects. For example, the controller 2520 may previously set an identification reference for a smart TV to a stand shape, a bezel shape, a screen shape, and a logo.

The controller 2520 according to an embodiment may select an identification reference corresponding to a kind of an object from among identification references which are previously set for kinds of a plurality of objects. Also, the controller 2520 may identify the object, based on the selected identification reference. For example, when the kind of the object is determined as a smart TV, the controller 2520 may identify the object, based on a stand shape, a bezel shape, a screen shape, and a logo which are identification references corresponding to the smart TV.

The method according to the various example embodiments may be implemented as computer-readable codes in a non-transitory computer readable recording medium. The computer-readable recording medium may include a program instruction, a local data file, a local data structure, or a combination thereof. The non-transitory computer-readable recording medium may be specific to example embodiments or commonly known to those of ordinary skill in computer software. The non-transitory computer-readable recording medium includes all types of recordable media in which computer readable data are stored. Examples of the non-transitory computer-readable recording medium include a magnetic medium, such as a hard disk, a floppy disk and a magnetic tape, an optical medium, such as a CD-ROM and a DVD, a magneto-optical medium, such as a floptical disk, and a hardware memory, such as a ROM, a RAM and a flash memory, specifically configured to store and execute program instructions. Furthermore, the computer readable recording medium may be implemented in the form of a transmission medium, such as light, wire or waveguide, to transmit signals which designate program instructions, local data structures and the like. Examples of the program instruction include machine code, which is generated by a compiler, and a high level language, which is executed by a computer using an interpreter and so on.

An apparatus according to the various example embodiments may include a processor, a memory storing and executing program data, a permanent storage such as a disk drive, a communication port for communication with an external device, a user interface device such as a touch panel, keys or buttons, and the like. The computer-readable recording medium may also be distributed over network-coupled computer systems so that the computer readable code is stored and executed in a distributed fashion. The medium may be read by a computer, stored in a memory, and executed by the processor.

Reference numerals are used in the various example embodiments illustrated in the drawings, and specific terms are used to explain the embodiments; however, they are not intended to limit the embodiments and may represent all the components that could be considered by those of ordinary skill in the art.

The embodiments may be embodied as functional blocks and various processing operations. The functional blocks may be implemented with various hardware and/or software configurations executing specific functions. For example, the embodiments employs integrated circuit configurations such as a memory, processing, logic, a look-up table and the like capable of executing various functions upon control of microprocessors or other control devices. In a similar manner to that in which the elements of the present disclosure may be executed with software programming or software elements, the embodiments may be implemented with a scripting language or a programming language such as C, C++, Java, assembler, and the like, including various algorithms implemented by a combination of data structures, processes, processes, routines or other programming configurations. The functional aspects may be implemented by algorithms executed in one or more processors. Also, the present disclosure may employ conversional arts to establish an electronic environment, process signals and/or process data. The terms “mechanism”, “element”, “means” and “configuration” may be widely used and are not limited to mechanical and physical configurations. Such terms may have the meaning of a series of routines of software in association with a processor or the like.

Specific executions described herein are merely examples and do not limit the scope of the present disclosure in any way. For simplicity of description, other functional aspects of conventional electronic configurations, control systems, software and the systems may be omitted. Furthermore, line connections or connection members between elements depicted in the drawings represent functional connections and/or physical or circuit connections by way of example, and in actual applications, they may be replaced or embodied as various additional functional connection, physical connection or circuit connections. Also, the described elements may not be inevitably required elements for the application of the present disclosure unless they are specifically mentioned as being “essential” or “critical.”

The singular forms “a,” “an” and “the” in this present disclosure, in particular, claims, may be intended to include the plural forms as well. Unless otherwise defined, the ranges defined herein is intended to include any embodiment to which values within the range are individually applied and may be considered to be the same as individual values comprising the range in the detailed description of the present disclosure. Finally, operations comprising the method of the present disclosure may be performed in appropriate order unless explicitly described in terms of order or described to the contrary. The present disclosure is not necessarily limited to the order of operations given in the description. The examples or example terms (for example, etc.) used herein are to merely describe the present disclosure in detail and not intended to limit the present disclosure unless defined by the following claims. Also, those of ordinary skill in the art will readily appreciate that many alternations, combinations and modifications, may be made according to design conditions and factors within the scope of the appended claims and their equivalents.

It should be understood that the various example embodiments described herein should be considered in a descriptive sense only and not for purposes of limitation. Descriptions of features or aspects within each embodiment should typically be considered as available for other similar features or aspects in other embodiments.

While one or more example embodiments have been described with reference to the figures, it will be understood by those of ordinary skill in the art that various changes in form and details may be made therein without departing from the spirit and scope as defined by the following claims.

What is claimed is:

1. A method of providing, by a device, information about an object, the method comprising:
analyzing a shape of the object based on an image including the object to determine a kind of the object;
identifying the object based on an identification reference corresponding to the determined kind of the object from among a plurality of identification references which are previously set in the device; and
displaying information about the identified object on a screen of the device.

2. The method of claim 1, wherein the identifying of the object comprises:
detecting at least one portion of the object, indicated by the identification reference corresponding to the determined kind of the object, from the image including the object; and
comparing the detected at least one portion of the object with partial feature information about each of a plurality of objects, which is previously stored in association with the determined kind of the object, to identify the object.

3. The method of claim 2, wherein the partial feature information comprises information including a ratio of the at least one portion of the object to a ratio of a screen length and information about one or more of: a shape, a texture, and a color of the at least one portion of the object.

4. The method of claim 1, wherein the information about the identified object comprises at least one of: performance information about the object, price information about the object, and user reaction information about the object.

5. The method of claim 1, further comprising:
providing guide information for obtaining an additional image including the object;
obtaining the additional image including the object when the object is sensed based on the provided guide information; and
selecting at least one identification reference from among the previously set plurality of identification references, based on the obtained additional image.

6. The method of claim 1, further comprising:
when text is included in the image including the object, identifying the text; and
identifying the object, based on the identified text.

7. The method of claim 1, wherein the displaying comprises displaying the information about the identified object within a certain distance range from the object in an image of the object displayed on the screen of the device.

8. The method of claim 1, further comprising: requesting the information about the identified object from an external server,
wherein the displaying comprises displaying the information about the identified object which is received in response to the request.

9. The method of claim 1, wherein the identifying of the object comprises:
when there are a plurality of candidate objects predicted as the object as a result of the identification of the object, selecting a detailed identification reference for identifying the plurality of candidate objects based on the selected identification reference; and
selecting one candidate object from among the plurality of candidate objects, based on the selected detailed identification reference.

10. A device configured to provide information about an object, the device comprising:
a photographing unit comprising a camera configured to obtain an image including the object;
a controller configured to analyze a shape of the object based on an image including the object to determine a kind of the object, and to identify the object based on an identification reference corresponding to the determined kind of the object from among a plurality of identification references which are previously set in the device; and
an output unit comprising output circuitry configured to display information about the identified object on a screen of the device.

11. The device of claim 10, wherein the controller is further configured to detect at least one portion of the object, indicated by the identification reference corresponding to the determined kind of the object, from the image including the object, and to compare the detected at least one portion of the object with partial feature information about each of a plurality of objects, which is previously stored in association with the determined kind of the object, to identify the object.

12. The device of claim 11, wherein the partial feature information comprises information including a ratio of the at least one portion of the object to a ratio of a screen length and information about one or more of: a shape, a texture, and a color of the at least one portion of the object.

13. The device of claim 10, wherein the information about the identified object comprises at least one of: performance information about the object, price information about the object, and user reaction information about the object.

14. The device of claim 10, wherein the controller is further configured to provide guide information for obtaining an additional image including the object, to obtain the additional image including the object when the object is sensed based on the provided guide information, and to select at least one identification reference from among the previously set plurality of identification references, based on the obtained additional image.

15. The device of claim 10, wherein when text is included in the image including the object, the controller is further configured to identify the text and to identify the object based on the identified text.

16. The device of claim 10, wherein the output unit is further configured to display the information about the identified object within a certain distance range from the object in an image of the object displayed on the screen of the device.

17. The device of claim 10, further comprising: a communicator comprising communication circuitry configured to request the information about the identified object from an external server,
wherein the output unit is further configured to display the information about the identified object, which is received in response to the request.

18. The device of claim 10, wherein when there are a plurality of candidate objects predicted as the object as a result of the identification of the object, the controller is further configured to select a detailed identification reference for identifying the plurality of candidate objects based on the selected identification reference, and to select one candidate object from among the plurality of candidate objects based on the selected detailed identification reference.

19. A server configured to provide information about an object, the server comprising:
a communicator comprising communication circuitry configured to receive an image including the object from a device; and
a controller configured to analyze a shape of the object based on the image including the object to determine a kind of the object, and to identify an object based on an identification reference corresponding to the determined kind of the object from among a plurality of identification references which are previously set in the server,
wherein the communicator is further configured to transmit information about the identified object to the device.

20. A non-transitory computer-readable recording medium having recorded thereon a program for executing the method of claim 1.
